(19) United States
(12) Patent Application Publication
(10) Pub. No.: US 2026/0188147 A1
(43) Pub. Date: Jul. 2, 2026

(54) EXTENDED REALITY HEADSET, SYSTEM AND APPARATUS

(71) Applicant: Vincent LEETZ, Amsterdam (NL)

(72) Inventor: Vincent LEETZ, Amsterdam (NL)

(21) Appl. No.: 18/867,644

(22) PCT Filed: May 23, 2023
(86) PCT No.: PCT/GB2023/051349

§ 371 Date: Nov. 20, 2024

(30) Foreign Application Priority Data
May 23, 2022 (WO) PCT/EP2022/063827
Oct. 11, 2022 (GB) 2214985.0

(51) Int. Cl. G09G 3/00; G02B 27/01; G06F 3/023; H04N 23/69; H04N 23/90

(52) U.S. Cl. CPC G09G 3/001; G02B 27/0172; G06F 3/023; G09G 2330/02; G09G 2354/00; H04N 23/69; H04N 23/90

(57) ABSTRACT

An extended reality (XR) headset (10; 1010; 2010) comprises a headset body (12) which includes a lens support (14), and a first lens (16; 1016) and a second lens (18) which are configured to display AR and MR thereon. A first lens cover (20) and a second lens cover (22) at least one of which are movable so as to cover the corresponding said first or second lenses (16, 18; 1016). The, preferably pivotable, first and the second lens covers (20, 22) are configured to display AR, MR and VR thereon via first and second data display elements (76, 78; 1176, 1178). A front facing camera (24) and a head mounting element (42) are provided on the headset body (12), and an electronic data processor (30) is configured to generate AR, MR and/or VR data, and to output said AR and/or MR data to at least one of the first and second lenses (16, 18; 1016), and/or to output said AR, MR and/or VR data to at least one of the first and second lens covers (20, 22).

The present application relates to an extended reality headset, and to an extended reality headset system and apparatus using such a headset.

Extended reality technology is also known as XR technology, or just ‘XR’. Herein and throughout, the term ‘XR’ is used and is intended to mean ‘extended reality’. Extended reality (XR) is an immersive experience which combines augmented reality (hereinafter referred to as ‘AR’), virtual reality (hereinafter referred to as ‘VR’) and mixed reality (hereinafter referred to as ‘MR’). Generally, these technologies can be used separately or combined using a display system. The display system can be a headset, a camera on a device or a lens on which the virtual character is projected. This can be used in a business environment, in education and most commonly spatial mapping or video games.

Augmented reality (AR) is where at least one virtual character and/or object is overlayed into the user's external surroundings, so it appears as though the virtual character and/or object is present in the user's environment. This is achieved, for example, through the use of a lens onto which the digital information is projected. Alternatively, a camera can be used in communication with a display screen, for example on a phone, where the camera captures the external world in real time, but the virtual character is overlayed into the user's surroundings.

Mixed reality (MR) is an advanced version of augmented reality where the virtual character and/or object displayed on the lens appears to interact with the user's physical external surroundings. It uses similar physical features as augmented reality glasses or headsets, but the mixed reality technology is further advanced using at least one sensor to allow the virtual character and/or object to appear to actually interact with the user's external surroundings.

Virtual reality (VR) is encompassed by the use of a headset which has a digital display onto which VR data is displayed and therefore the user can view a virtual world as the user's external surroundings are not visible. This type of headset is known to be cumbersome due to the distance required to form a clear image on the display for the user.

The combination of augmented reality, virtual reality and mixed reality gives rise to an extended reality (XR) device. In a first example, the device is in the form of a VR headset, but with either at least one front facing built-in camera and sometimes at least one side facing camera through which the user can observe what is directly in front of them as well as what is present at the peripheries. In a second example, the VR headset can also be combined with lenses through which the user can observe the real world and also allows AR and/or MR data to be projected thereon. In the second example, the user would need to remove the VR aspect of the device via either flipping up the VR display or removing the VR display from the headset in order to see the real world.

In current designs, if the user would like to view their external surroundings, the user has to deprive themselves fully of the AR, MR and/or VR display by moving the display out of alignment with the lenses or even by removing the entire XR headset from the user's face. Additionally, current designs only allow the user to observe what is directly in front of them, and some current designs provide the user with a peripheral view of their external surroundings. Current designs do not, however, provide the user with the full 360° virtual experience when the user is stationary.

It is the object of the present invention to overcome the above issues.

According to a first aspect of the invention, there is provided an extended reality (XR) headset for experiencing virtual reality (VR), augmented reality (AR) and mixed reality (MR), the extended reality headset comprising: a headset body including: a lens support; a first lens and a second lens which are supported by the lens support and which are configured to display AR and MR thereon; a first lens cover and a second lens cover at least one of the first and second lens covers being movable so as to cover the corresponding said first or second lens, the first and the second lens covers, preferably including first and second data display elements, respectively, which display AR, MR and VR thereon; and a front facing camera located at or adjacent to a central portion of the lens support, the front facing camera being configured to receive a view of the environment at and/or in the vicinity of an exterior of the lens support; a head mounting element extending from the headset body; and an electronic data processor on at least one of the headset body and/or the head mounting element, the electronic data processor being configured to generate AR, MR and/or VR data, and to output said AR and/or MR data to at least one of the first and second lenses, and/or to output said AR, MR and/or VR data to at least one of the first and second lens covers.

The structure of the XR headset is advantageously not bulky and fits onto the user's head much like a pair of eyewear. The XR headset advantageously provides the user with the option of AR, MR and/or VR data and therefore the user can have an immersive experience either by viewing their external environment through the first lens and experiencing AR and/or MR data or not viewing their external environment and instead viewing VR data.

The lens support supports the first and second lenses, onto which the AR and/or MR data is projected so that the user can view their external environment and the AR and/or MR data can appear to interact with the user's surroundings. Furthermore, the user is also able to view their external surroundings directly through the first lens without any AR and/or MR data being projected onto said first lens to avoid tripping over obstacles. Advantageously, the head mounting element fits over the user's head and/or over the user's ears and therefore provides the XR headset with a means to remain stationary on the user's head, resulting in the user having a more immersive experience as they are not distracted by the XR headset falling off.

Beneficially, the first and second lens covers have a first further lens and a second further lens, respectively, which enable a user to focus on the data displayed on the said first and second data display elements.

Additionally, or alternatively, the head mounting element may include a rear facing camera attached to a rear-facing camera portion mounted at an intersection between first and second headset retaining straps.

Furthermore, at least one lens-cover light-seal may be provided at the lens support which thus prevents or inhibits light transmission between the first and second lenses and the respective first and second lens covers.

Optionally, the second lens cover is fixed to a lens-cover facing surface of the lens support so as to be stationary or immovable relative to the associated second lens. This allows the user to always have an option to view the external environment through the second data display element even if the first lens is uncovered.

Preferably, the front facing camera is a fish-eye camera for providing the user with a wide-angle exterior view. This is advantageous because the user will be able to view a wide angle of their external surroundings and therefore have a more immersive experience.

Optionally, the lens support may further include a mounting element onto which the first and second lens covers are mounted. The mounting element is advantageous as it provides a support for the first and second lens covers to be mounted onto and therefore a point for the first lens cover to pivot about.

Advantageously, the mounting element preferably further includes a first lens-cover pivot element by which the first lens cover is pivotably mounted to the lens support. The first lens cover is able to pivot about the first lens cover pivot element which in turn covers and uncovers the first lens so that the user can switch between AR, MR or VR data.

Optionally, the XR headset preferably further comprises at least one navigation button enabling navigation between AR, MR and/or VR data. This is advantageous as the AR, MR and VR data can be selected between by using an easy to access button which increases the efficiency of selecting between the said data.

A first said navigation button is preferably associated with the first lens and/or first lens cover, and a second said navigation button is associated with the second lens and/or the second lens cover. Having the first said navigation button associated with the first lens and/or first lens cover increases the simplicity and efficiency of controlling the data viewed by the first lens and/or first lens cover as well as controlling the associated movement of the first lens cover. Similarly, having the second said navigation button associated with the second lens and/or second lens cover increases the simplicity and efficiency of controlling the data viewed by the second lens and/or second lens cover. Advantageously, both the first and second navigation buttons may be synchronized at the same time or individually with both the first and/or second lenses and first and/or second lens covers, and therefore the first navigation button may be coordinated with the second lens cover and the second navigation button may be coordinated with the first lens cover.

Preferably, the or each said navigation button is mounted on the mounting element. Having the navigation buttons mounted to the mounting element means that the user can easily locate the navigation buttons on the headset. Furthermore, the position of the navigation buttons means that the user is less likely to accidentally come into contact with the navigation buttons. If, for example, the navigation buttons were situated on the inside of the arm members or at the end portion of the arm members then it is more likely that the user will accidentally come into contact with the navigation buttons.

Preferably, the lens support may comprise at least one further front facing camera with an automated zoom function. This is advantageous as the user is able to utilise multiple cameras to obtain differing images of their external surroundings. The further front facing cameras allow the user to zoom in relative to their external surroundings to provide a more immersive experience.

Advantageously, the headset body preferably further comprises at least one digital projector which is communicable with the electronic data processor, the digital projector being able to project AR and/or MR digital media onto the first and/or second lens. The digital projector projects the AR and/or MR digital media onto the first and/or second lens which provides the user with an immersive experience while also viewing their external surroundings through the first lens. This provides the user with the ability to view their external surroundings without the use of the front facing camera and therefore gives the user a break from having their view blocked by the first lens cover.

Preferably, the first and second data display elements receive AR, MR and/or VR data transmitted from the electronic data processor. The first and second data display elements display the AR, MR and/or VR data to the user while the first and second lens covers are in the lens-covered position. If the user is experiencing AR and/or MR data, then at least the front facing camera will be utilised to display the user's external surroundings onto the first and second data display elements. If the user is experiencing VR data, then the front facing cameras are preferably not utilised as the electronic data processor generates VR data which is fully immersive and therefore there is no interaction with the user's external environment.

Optionally, the digital projector and the data display element are preferably individually or jointly activated via a switching element. The switching element advantageously activates the digital projector or the data display element in separate situations, depending on whether the user would like to experience AR, MR or VR data.

Preferably, the first lens cover may have a lens-covered position and a lens-uncovered position to respectfully cover and uncover the first lens, the lens-covered position activating at least the associated data display element via the switching element, and the lens-uncovered position activating at least the digital projector via the associated switching element. This is advantageous because depending on the position of the first, and in some embodiments the movable second, lens covers a different feature is activated via the switching element or switching elements. The lens-uncovered position allows the user to view their external environment through the first lens. It is advantageous that the first and/or second data display elements may switch off automatically once the first and/or second lens cover is in the lens-uncovered position. The digital projector can subsequently be activated in order to display the AR and/or MR digital media on the first and/or second lenses.

It is also advantageous that only the first lens cover display element may automatically switch off when the first lens cover is in the lens-uncovered position.

Optionally, the data display element associated with the second lens cover may subsequently continue displaying data while the first lens cover is in the lens-uncovered position.

It is envisaged that there will preferably still be the option to manually switch on and off the second lens cover display irrespective of the state of the first lens cover display or vice versa.

Advantageously, the switching element preferably relays or transmits automatic on and off commands between the first and/or second lenses and/or the first and/or second lens covers depending if the first and/or second lens covers is/are in the lens-covered or lens-uncovered positions.

Optionally, the head mounting element is preferably at least in part an arm element which can be rested on a user's ear to support the headset body on a face of the user. The arm element provides the XR headset with stability on the user's head and therefore the XR headset fits onto the user's head like a pair of eyewear.

Advantageously, the head mounting element preferably includes a rear facing camera. The presence of the rear facing camera allows the user to view behind them while they are using the XR headset. This prevents the user from encountering or even from tripping over obstacles once they are using the XR headset and therefore increases the safety of the XR headset. Of course, this XR headset device will not explicitly be able to prevent the fall or bumping into objects. The extra focal point from the rear allows for the warning of dangers, such as edges or obstacles. The user will still need to be mindful and mitigate falling and bumping into obstacles, or getting hit by something or an object. Due to the various signals and sensors, the XR headset device creates a safer environment.

Preferably, the head mounting element may include a headset securing means to which the rear facing camera is mounted. Advantageously, the rear facing camera is secured to a headset securing means and therefore this will provide the user with a stable and clear image of what is behind them in the external environment as the rear facing camera is attached to the head mounting element and therefore connected to the headset body.

Optionally, the headset securing means preferably includes a horizontal strap. Having a horizontal strap is advantageous as this secures the XR headset to the user's head so that when the user is in motion the XR headset does not fall off the user's head.

Furthermore, the headset securing means preferably includes a vertical strap. Having a vertical strap is advantageous as this secures the XR headset to the user's head so that when the user is in motion the XR headset does not fall off the user's head.

Preferably, a rear facing camera portion for attaching the rear facing camera thereto may be located at an intersection between the horizonal and vertical straps. This is advantageous as the rear facing camera will be secured to the user's head as the horizontal and vertical straps are stationary and interconnected. Therefore, the rear facing camera will also be stationary and provide the user with a clear view of what is behind them.

Optionally, the headset securing means preferably has a rear facing camera portion for attaching the rear facing camera thereto. This is advantageous as the rear facing camera will be secured to the user's head and thus the camera will be stationary. This will therefore provide the user with a clear view of what is behind them.

Advantageously, the lens support preferably includes at least one lens-cover seal for preventing or inhibiting light transmission between the first and second lenses and the respective first and second lens covers. This is advantageous as the user's view of the first and second data display elements will not be reduced in quality due to light entering the user's line of sight. Therefore, the lens-cover seal improves the user's immersive experience.

Optionally, the lens-cover seal is preferably a flexible ring. Having the lens-cover seal as a flexible ring is advantageous because when the first lens cover is in the lens-covered position, the contact between the first lens cover to the lens-cover seal is cushioned and therefore tighter seal is created between the first lens cover and the lens-cover seal.

Preferably, the XR headset further comprises at least one microphone for receiving an audio input. The microphone further improves the user's immersive experience as the user can speak into the microphone to communicate to a further user when the two users are using discrete XR headsets. The user can also provide spoken commands to the XR headset to select certain options.

Preferably, the XR headset further comprises at least one speaker for outputting an audio signal. The speaker further improves the user's immersive experience as the user is able to view AR, MR and/or VR data while hearing audio associated with the data. Furthermore, the user can also hear audio from the further user when the two users are communicating.

Advantageously, the said at least one speaker may form part of an audio earpiece. The user can then subsequently listen to the audio associated with the AR, MR and/or VR data through the audio earpieces and therefore the audio does not leak into the external environment, providing clearer audio to the user.

Optionally, the XR headset preferably further comprises a charging port for charging an onboard power source of the extended reality headset. This is advantageous as the onboard power source of the XR headset can be charged to ensure that the XR headset is able to turn on when the user would like to use the XR headset.

Preferably, the XR headset further comprises a short-range wireless-data transceiver which is associated with the electronic data processor. The short-range wireless-data transceiver receives and transmits AR, MR and/or VR data wirelessly which allows the user to move around freely when using the XR headset as there are no wires required to receive and transmit data to the XR headset.

Preferably, the XR headset further comprises at least one attachment member to secure the head mounting element to the headset. This advantageously ensures that the head mounting element is attached to the XR headset and therefore ensures that the XR headset does not fall off the user's head.

Preferably, there is an extended reality (XR) headset system comprising an extended reality headset in accordance with the first aspect of the invention, and a server, the extended reality headset being wirelessly communicable with the said server. This is advantageous as the XR headset can connect wirelessly to the server via the short-range wireless-data transceiver and therefore the user can move freely when the user is using the XR headset. The XR headset will therefore also receive wireless AR, MR and/or VR data directly from the server to the short-range wireless-data transceiver.

Preferably, there is an extended reality (XR) headset apparatus comprising an extended reality headset in accordance with the first aspect of the invention, and an external battery pack which is releasably connectable to the extended reality headset to charge an onboard power source. This is advantageous as the user can charge the onboard power source via the external battery pack while the user is using the XR headset which means that the user does not need to charge the XR headset via mains power.

Preferably, the XR headset further comprises a mains connection cable for connecting the extended reality headset to a mains power source. This is advantageous as when the user is not using the XR headset, the XR headset can be charged by the mains power source via the mains connection cable.

An extended reality (XR) headset is provided for experiencing virtual reality (VR), augmented reality (AR) and mixed reality (MR), the extended reality headset comprising: a liquid proof headset body including: a first lens and a second lens configured to display AR and MR thereon; a lens support for mounting the first lens and the second lens thereon which are spaced apart by a central portion having at least one light emitting device and at least one nose contact element and at least one front camera; a front facing fish-eye camera located at or adjacent to the central portion of the headset body, the front facing fish-eye camera being configured to display a real world view; a first lens cover and a second lens cover, the first and second lens cover covering the first lens and the second lens respectively, the first and the second lens covers being configured to display AR, MR and VR thereon, the first lens cover being movable via a first lens cover pivot; a face seal mounted on the lens support, the face seal surrounding the first and second lenses; a first navigation button and a second navigation button being located on the first and second lens cover pivots, respectively; a short-range wireless transceiver; a microphone; at least one speaker, a charging port; a charging port cover being connectable to the charging port; a head mounting element extending from the headset body, the head mounting element being attachable to the lens support via at least one bracket member and at least one ring member; an onboard power source disposed within the head mounting element; a rear facing camera being locatable on the head mounting element; and an electronic data processor on at least one of the headset body and/or the head mounting element, the electronic data processor being configured to generate AR, MR and/or VR data, and to output said AR and/or MR data to at least one of the first and second lenses, and/or to output said AR, MR and/or VR data to at least one of the first and second lens covers.

The features of the XR headset advantageously provide the user with a full immersive AR, MR or VR experience. The user is able to select between the AR, MR and/or VR experience using the navigation buttons. Depending on whether the first and second lens cover is covered, the user can experience AR, MR and/or VR data. For example, when the first lens is covered, the user experiences AR, MR or VR data, but when the first lens is uncovered, the user experiences AR and/or MR data.

The charging port provides the user with a means or system to charge the XR headset and thus ensure that the user is able to use the headset when they so wish.

The liquid-proof body is also advantageous as the user is able to use the XR headset in an aquatic environment, for example for educational reasons.

An extended reality (XR) headset system, in accordance with a second aspect of the invention, for experiencing virtual reality (VR), augmented reality (AR) and mixed reality (MR), the extended reality headset system being data-communicable with a pair of audio earpieces, the extended reality headset system comprising: a liquid proof headset body including: a first lens and a second lens configured to display AR and MR thereon; a lens support for mounting the first lens and the second lens thereon which are spaced apart by a central portion having at least one light emitting device and at least one nose contact element and at least one front camera; a front facing fish-eye camera located at or adjacent to the central portion of the headset body, the front facing fish-eye camera being configured to display a real world view; a first lens cover and a second lens cover, at least one of the first and second lens covers being movable, and preferably pivotable via a pivot element, so as to cover the corresponding said first lens or the second lens, the first and the second lens covers being configured to display AR, MR and VR thereon; a light prevention means mounted on the lens support, the light prevention means surrounding the first and second lenses; a navigation button being located on the or each said pivot element; a short-range wireless transceiver; a microphone; at least one speaker; a charging port; a charging port cover being connectable to the charging port; a head mounting element extending from the headset body, the head mounting element being attachable to the lens support via at least one bracket member and at least one ring member; a battery disposed within the head mounting element; a rear facing camera being locatable on the head mounting element; and an electronic data processor on at least one of the headset body and/or the head mounting element, the electronic data processor being configured to generate AR, MR and/or VR data, and to output said AR and/or MR data to at least one of the first and second lenses, and/or to output said AR, MR and/or VR data to at least one of the first and second lens covers.

The features of the XR headset advantageously provide the user with a full immersive AR, MR or VR experience. The use of the pair of audio earpieces with the XR headset allows the user to hear audio associated with the AR, MR or VR data transmitted to the short-range wireless-data transceiver from the server.

The features of the XR headset advantageously provide the user with a full immersive AR, MR or VR experience. The user is able to select between the AR, MR and/or VR experience using the navigation buttons. Depending on whether the first and second lens covers are covered, the user can experience AR, MR and/or VR data. For example, when the first lens is covered, the user experiences AR, MR or VR data, but when the first lens is uncovered, the user experiences AR and/or MR data.

The charging port provides the user with a means to charge the XR headset and thus ensure that the user is able to use the headset when they so wish.

The liquid-proof body is also advantageous as the user is able to use the XR headset in an aquatic environment, for example for educational reasons.

An extended reality (XR) headset, in accordance with a further aspect of the invention, for experiencing virtual reality (VR), augmented reality (AR) and mixed reality (MR), the extended reality headset comprising: a headset body including: a lens support; a first lens and a second lens which are supported by the lens support and which are configured to display AR and MR thereon; a first lens cover and a second lens cover, preferably by which the first and second lenses are respectively independently coverable, the first and the second lens covers being configured to display AR, MR and VR thereon; and a front facing camera located at or adjacent to a central portion of the lens support, the front facing camera being configured to receive a view of the environment at and/or in the vicinity of an exterior of the lens support; a head mounting element extending from the headset body; and an electronic data processor on at least one of the headset body and/or the head mounting element, the electronic data processor being configured to generate AR, MR and/or VR data, and to output said AR and/or MR data to at least one of the first and second lenses, and/or to output said AR, MR and/or VR data to at least one of the first and second lens covers.

The invention will now be more particularly described, by way of example only, with reference to the accompanying drawings, in which:

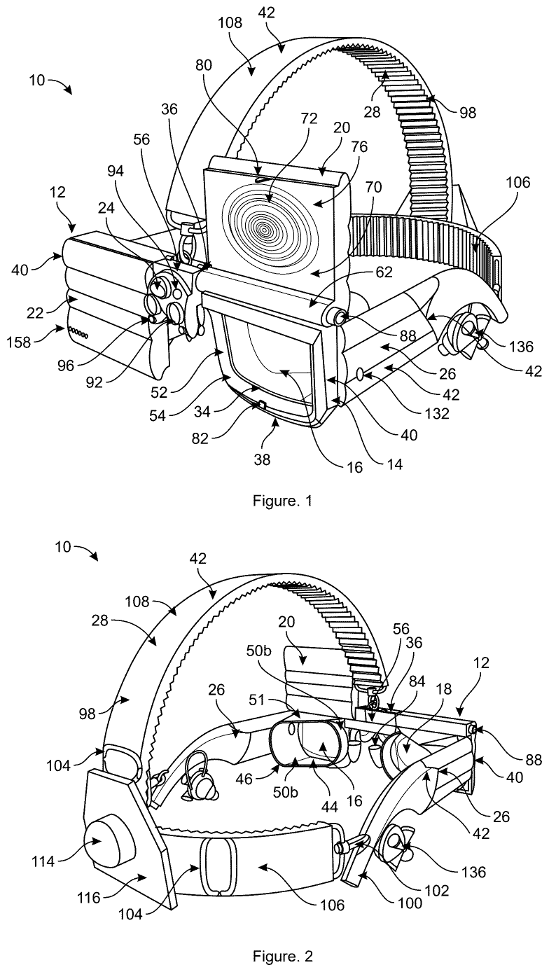

FIG. 1 shows a perspective view of a first embodiment of an extended reality (XR) headset in accordance with the invention, where a first lens cover is at a lens-uncovered position and a second lens cover is fixed in a lens-covered position;

FIG. 2 shows an alternative perspective view of FIG. 1, where a rear facing camera is visible on a rear facing camera portion;

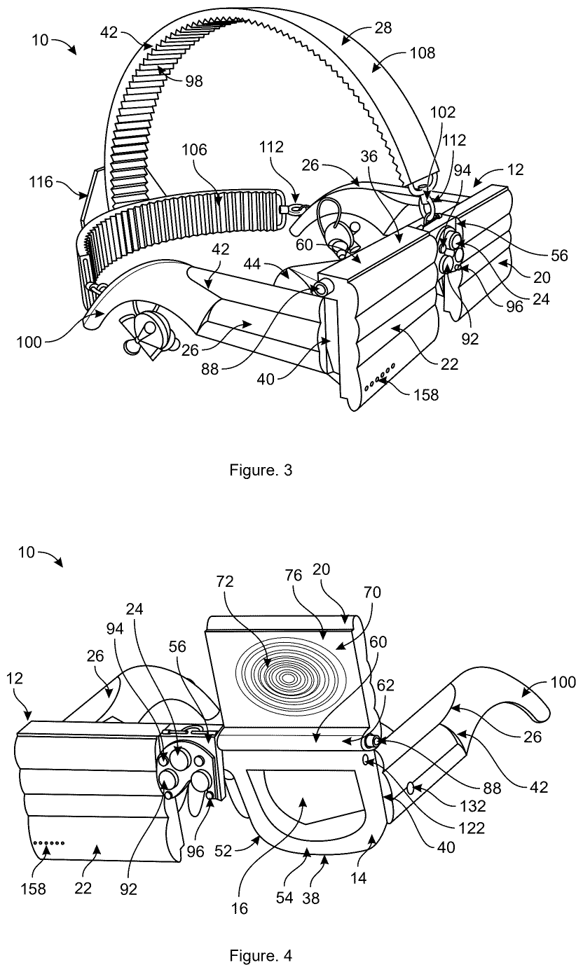

FIG. 3 shows a further alternative perspective view of FIG. 1 where the first lens cover is at a lens-covered position;

FIG. 4 shows a further alternative perspective view of FIG. 1 with features inclusive of a headset securing means, the rear facing camera and at least one audio earpiece being omitted for clarity;

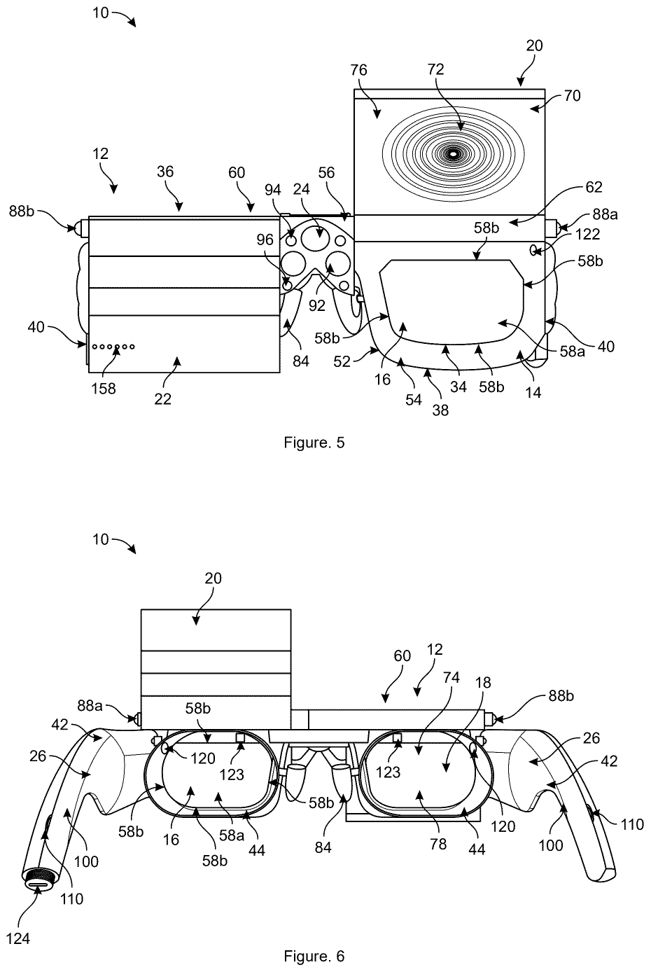

FIG. 5 is similar to FIG. 4, but showing the XR headset from the front;

FIG. 6 is the XR headset shown in FIG. 4, but from the rear;

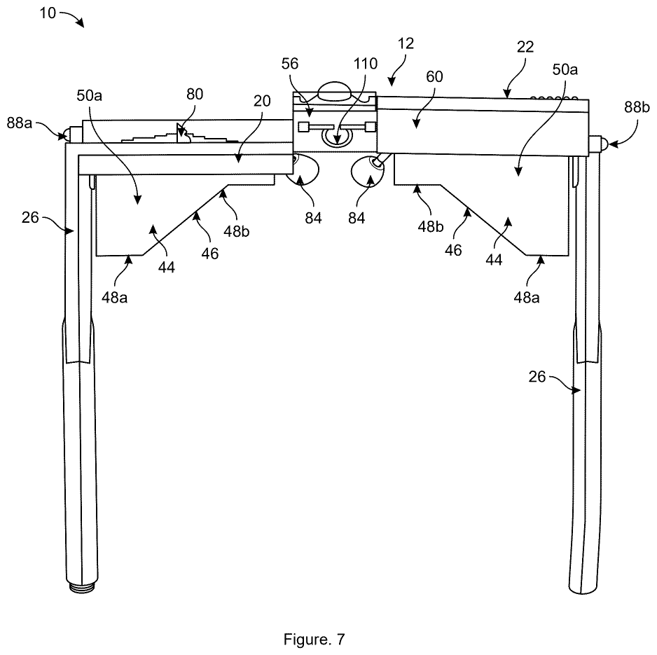

FIG. 7 is a top plan view of the XR headset of FIG. 4;

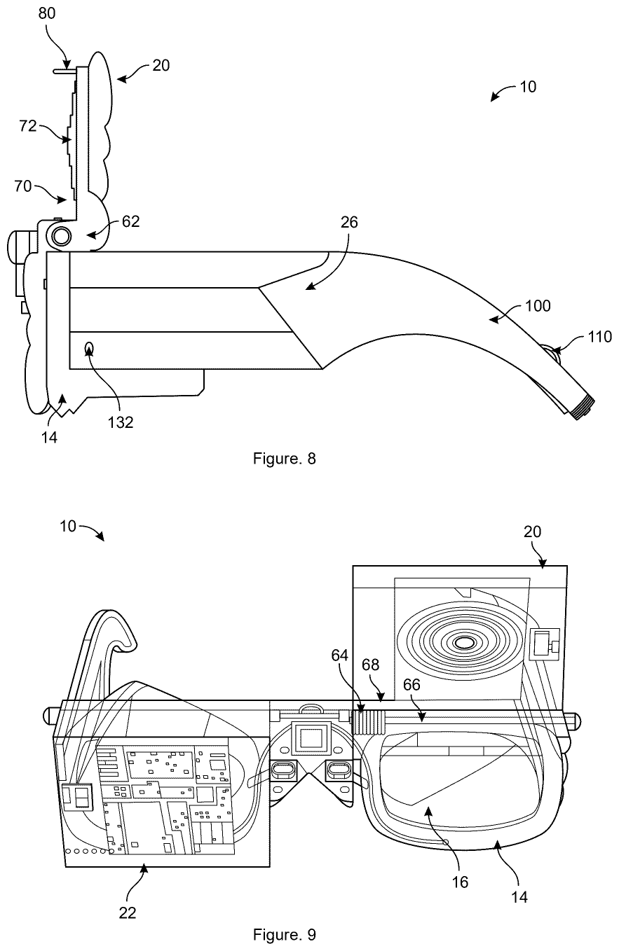

FIG. 8 shows a side view of the XR headset of FIG. 4;

FIG. 9 shows a front perspective view of the XR headset, similar to FIG. 5, and with a number of internal components shown in phantom;

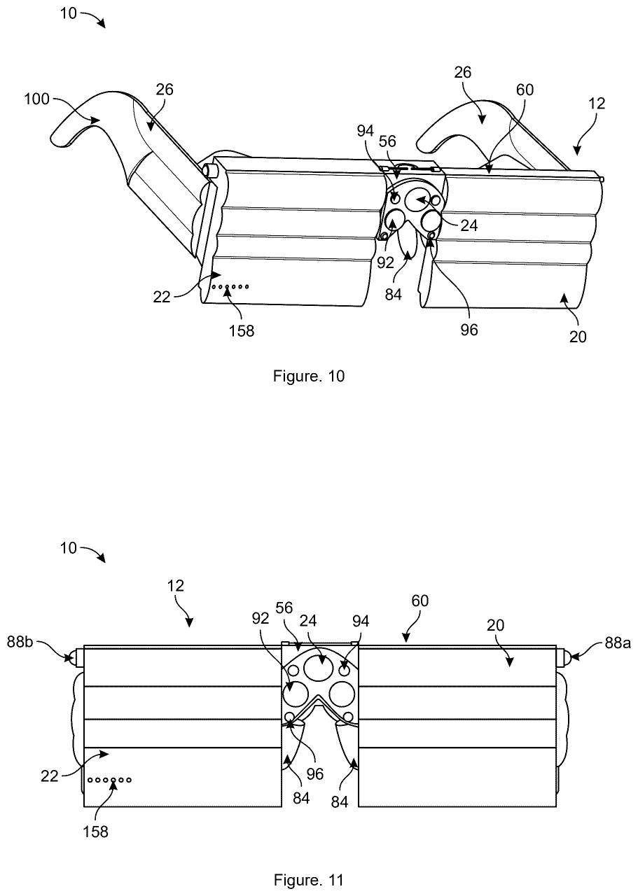

FIG. 10 is a perspective view of the XR headset, similar to FIG. 4 with a number of features omitted for clarity, and this time shown with both first and second lens covers in closed conditions;

FIG. 11 shows a front view of the XR headset of FIG. 10;

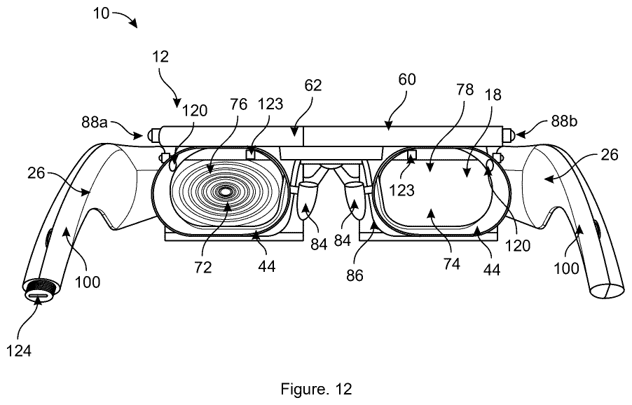

FIG. 12 is a rear view of the XR headset of FIG. 10;

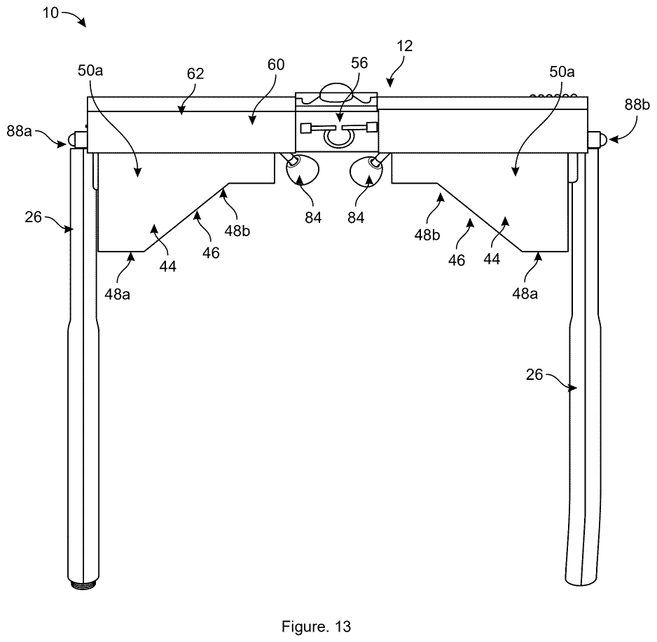

FIG. 13 shows a top plan view of the XR headset of FIG. 10;

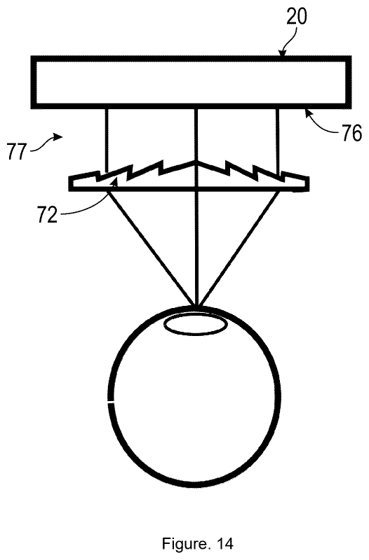

FIG. 14 shows a top plan view of the user's eye focusing on an image displayed on a first digital display element of the first lens cover, a Fresnel lens being present between the user's eye and the first data display element which helps the user's eye to focus on the first data display element;

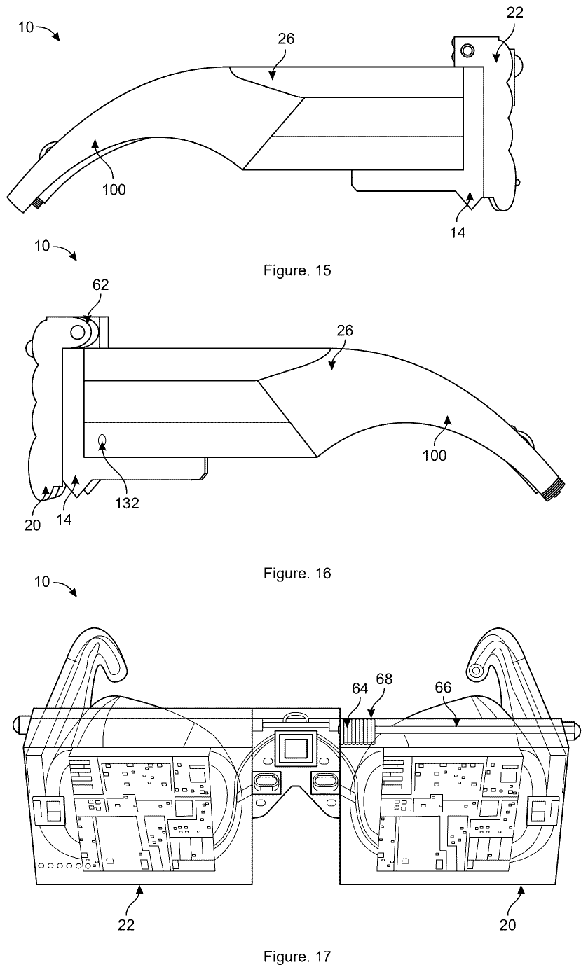

FIG. 15 shows a side view of the XR headset of FIG. 10;

FIG. 16 is similar to FIG. 15, showing a view of the XR headset seen in FIG. 10, but from the opposite side;

FIG. 17 shows a front perspective view of the XR headset in FIG. 10 and with a number of internal components shown in phantom;

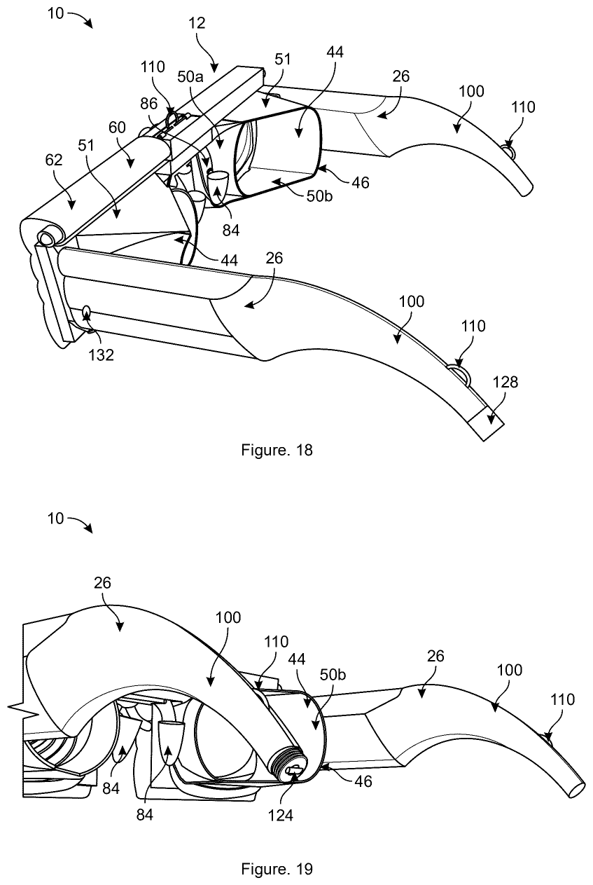

FIG. 18 shows a perspective view from the rear of the XR headset of FIG. 10;

FIG. 19 is an enlarged view of an ear-engagement portion of an arm of the XR headset shown in FIG. 10, a strap-connector is viewable at or adjacent to a mid-section of the ear-engagement portion, and a screw-threaded charging port can be seen at a distal end of the ear-engagement portion;

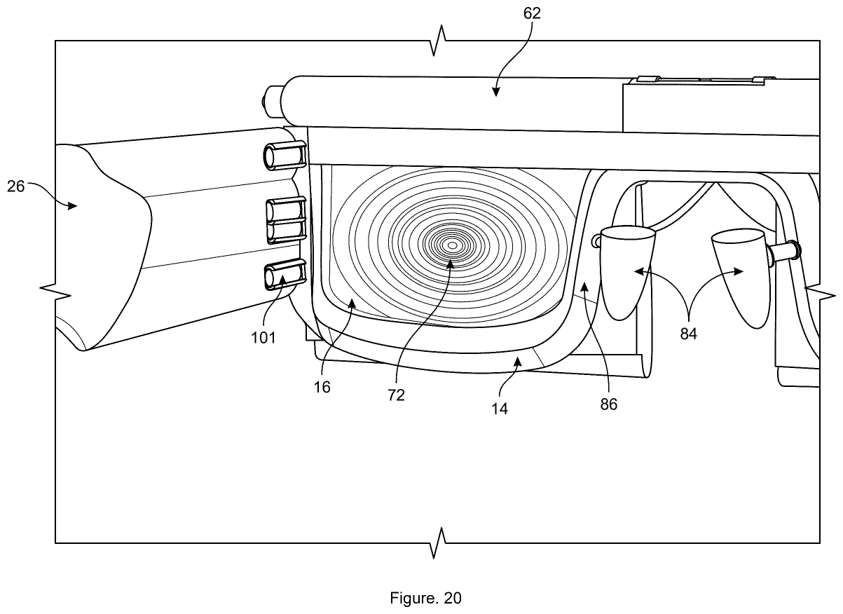

FIG. 20 shows an enlarged view of FIG. 19 with the face seal omitted for clarity to show clearly a hinge between an arm member and a lens support;

FIG. 21 is an enlarged front-side view of audio earpieces of the XR headset shown in FIG. 1 and in isolation of the remainder of the XR headset for clarity;

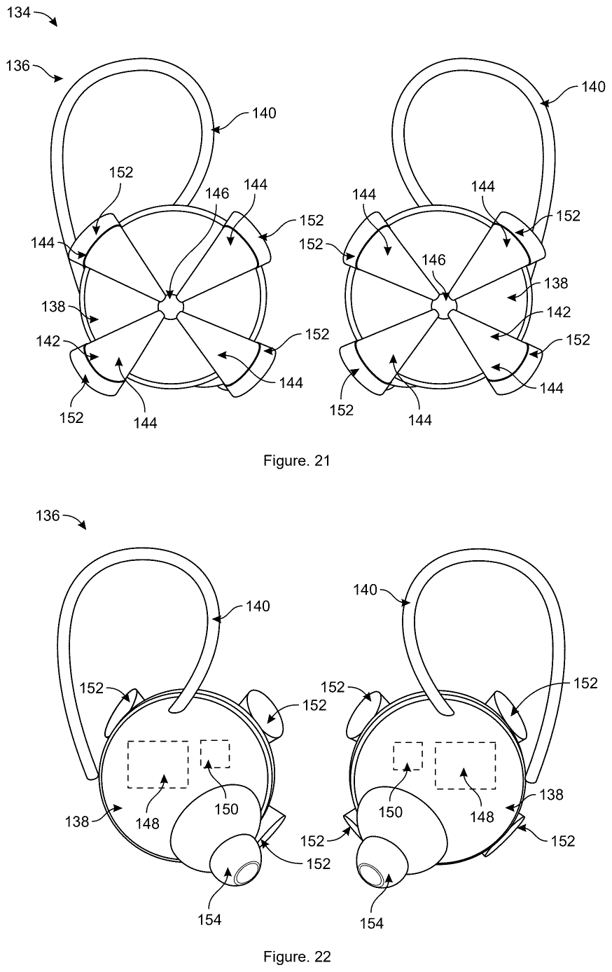

FIG. 22 shows a back-side view of the audio earpieces in FIG. 21;

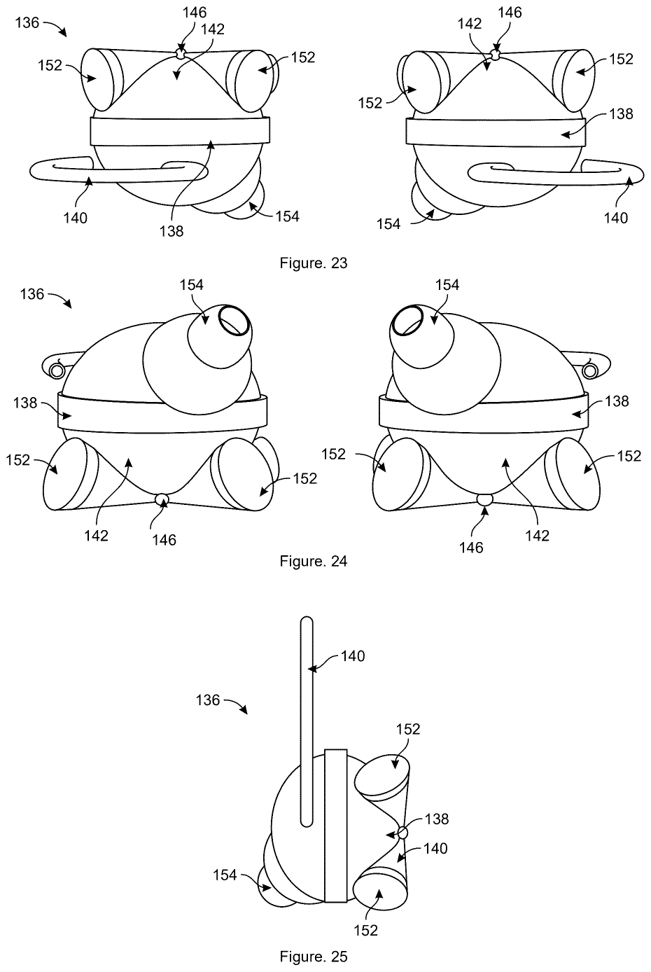

FIG. 23 is a top plan view of the pair of audio earpieces of FIG. 21;

FIG. 24 shows a bottom plan view of the pair of audio earpieces of FIG. 21;

FIG. 25 is an edge side view of a single one of the audio earpieces, shown in FIG. 21;

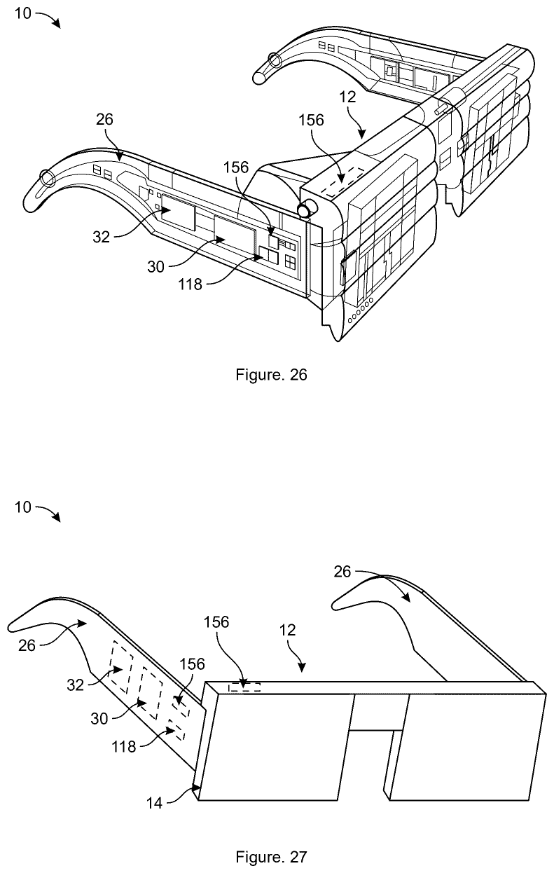

FIG. 26 shows a perspective view of FIG. 10 showing an electronic data processor, an onboard power source, a short-range wireless-data transceiver and a vibration element in phantom within the arm member of the XR headset;

FIG. 27 is a further simplified phantom representation of FIG. 26 showing the position of the internal features within the arm member and the lens support;

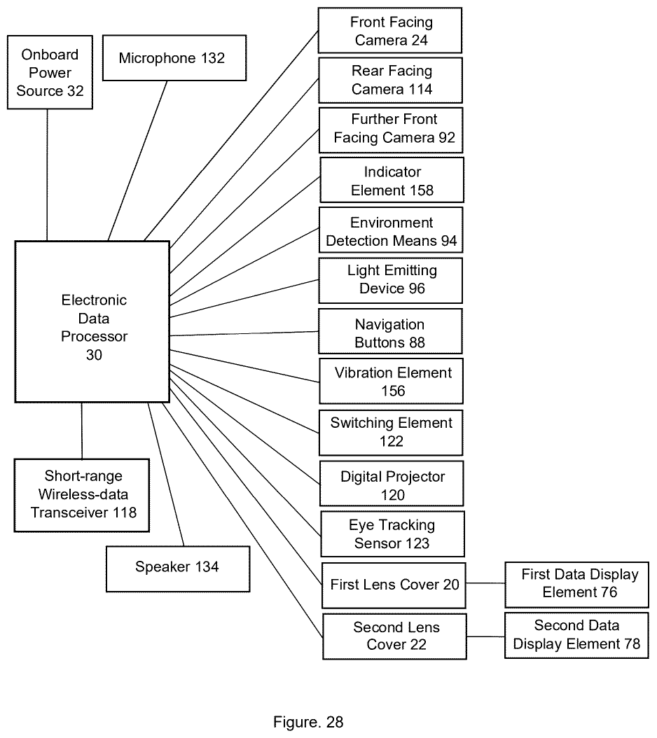

FIG. 28 is a simplified block diagram representing how the electronic data processor is electrically communicable with various internal features of the XR headset;

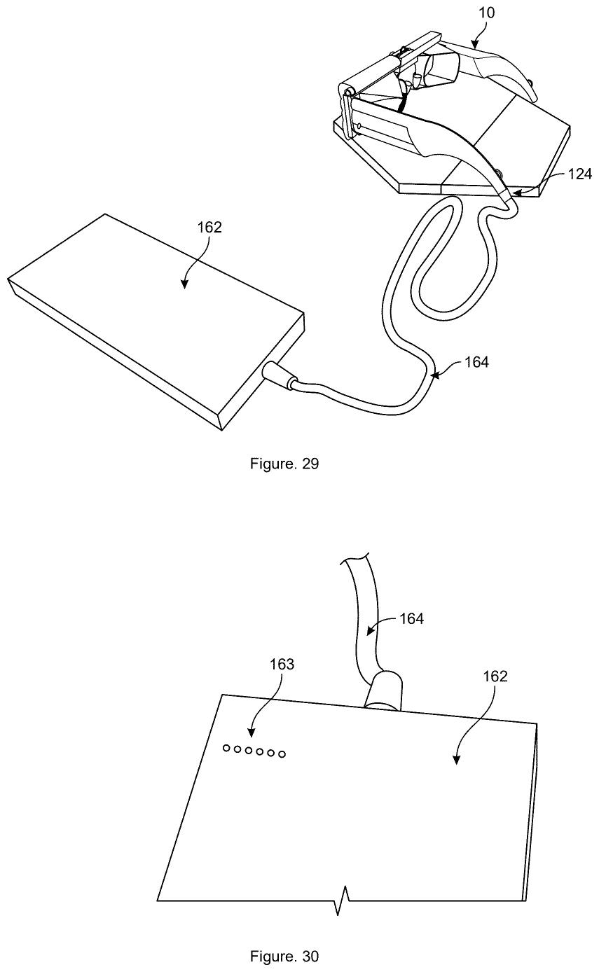

FIG. 29 shows an embodiment of an XR headset apparatus having the XR headset of FIG. 1, with some features omitted for clarity, connected to an external battery pack via the aforementioned charging port;

FIG. 30 shows an enlarged perspective view of FIG. 29, wherein six external battery indicator elements on the surface of the external battery pack are shown as six Light emitting Diode (LED) devices;

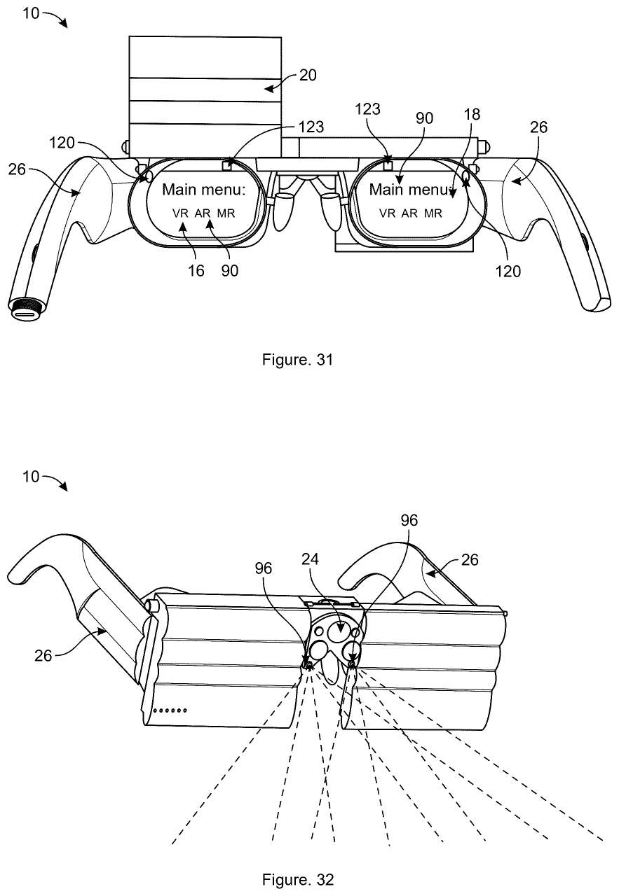

FIG. 31 shows the XR headset of FIG. 1 in-use and with features omitted for clarity, wherein, by way of example only, AR and/or MR data is shown projected onto a first lens and VR data is displayed on a second data display element;

FIG. 32 shows a perspective view of the XR headset, similar to FIG. 10, wherein an energised light emitting device is shown emitting light represented as beam lines;

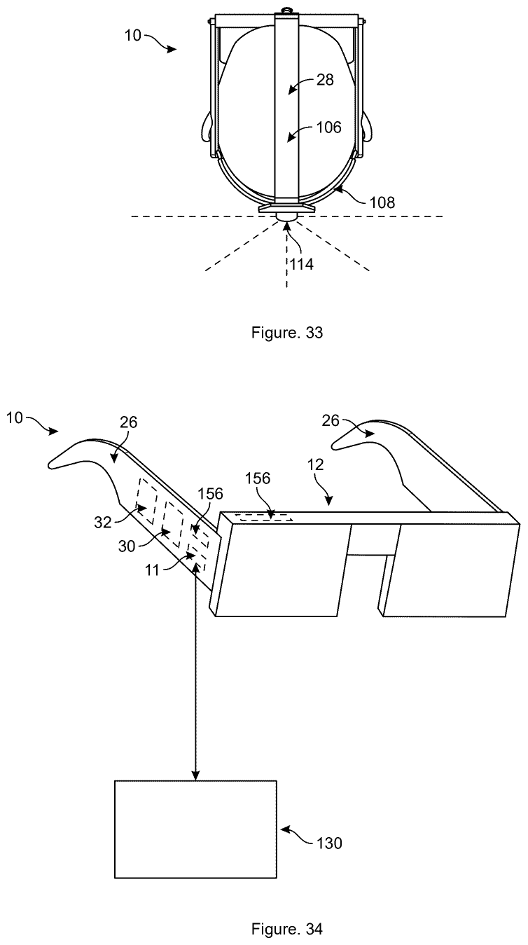

FIG. 33 shows a top plan representation of a user wearing the XR headset of FIG. 1, wherein the extent of the field-of-view of a rear facing camera is depicted;

FIG. 34 is a simplified block diagram of an embodiment of an XR headset system, showing an electronic data processor of the in-use XR headset of FIG. 1 receiving data from a server to generate AR, MR and/or VR data for display on the XR headset;

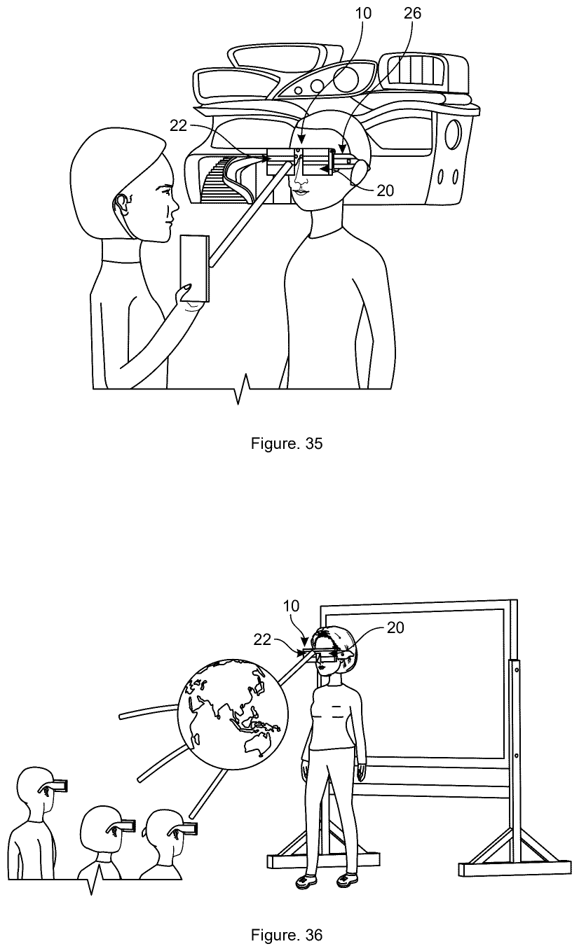

FIG. 35 is the in-use XR headset of FIG. 10, wherein the front facing camera identifies and processes data which is displayed on a customer's portable device to permit entry to an event;

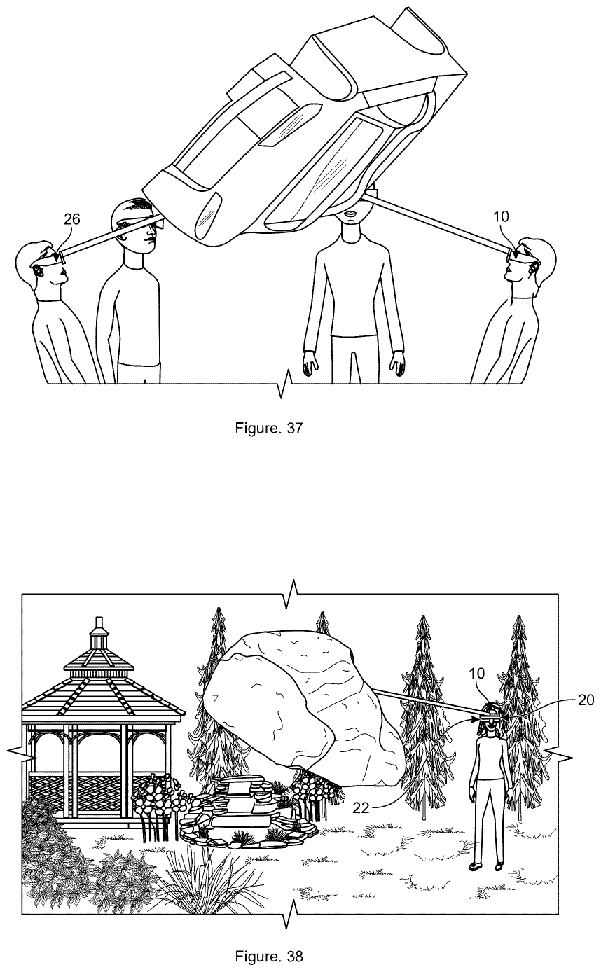

FIG. 36 shows a plurality of in-use XR headsets of FIG. 10 in an educational environment, all the XR headsets being in coordinated data-communication with a server to enable an educator, such as a teacher, to guide and impart knowledge to one or more students using AR, MR and/or VR generated data;

FIG. 37 shows a plurality of in-use XR headsets of FIG. 10 in a design or engineering environment, each one of the plurality of XR headsets is in communication with the same server, which with the aid of the front facing camera generates the same AR, VR and/or MR data relating to the project or subject on the first and/or second data display elements;

FIG. 38 shows the in-use XR headset of FIG. 10 generating AR and/or MR data on the first and/or second data display elements with the aid of the front facing camera and an environment detection means to determine the depth of the user's external environment for the user to accurately determine where a projected image may be placed in a home renovation environment;

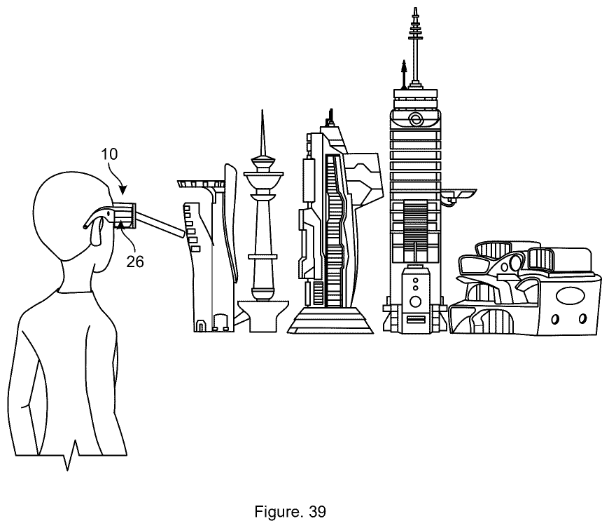

FIG. 39 shows the in-use XR headset of FIG. 10, wherein a short-range wireless-data transceiver therein receives data and generates VR data on the first and/or second data display elements for the user to experience;

FIG. 40 shows a perspective view of a second embodiment of an extended reality (XR) headset in accordance with the first aspect of the invention, wherein a first lens cover is at a lens-covered position and a second lens cover is fixed in a lens-covered position;

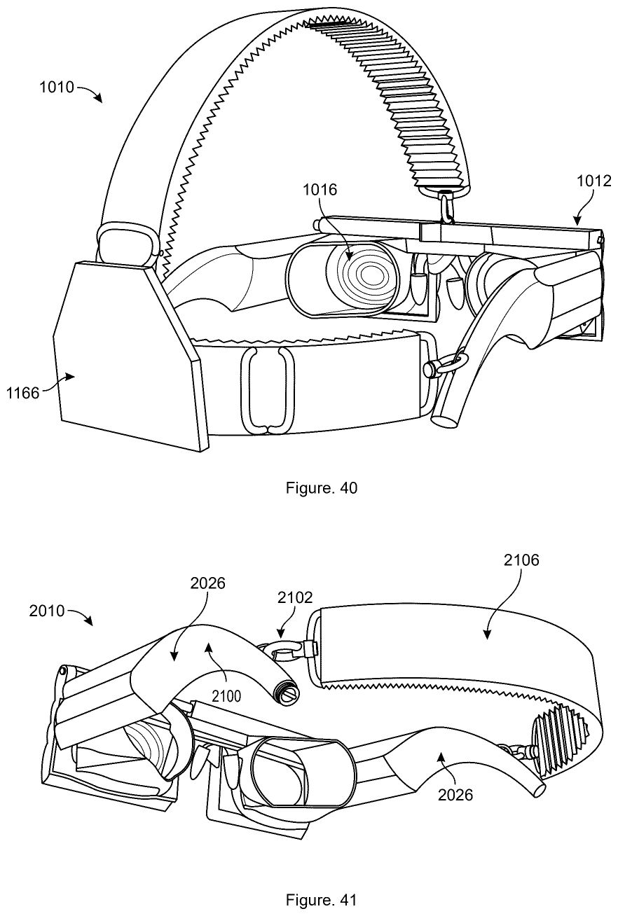

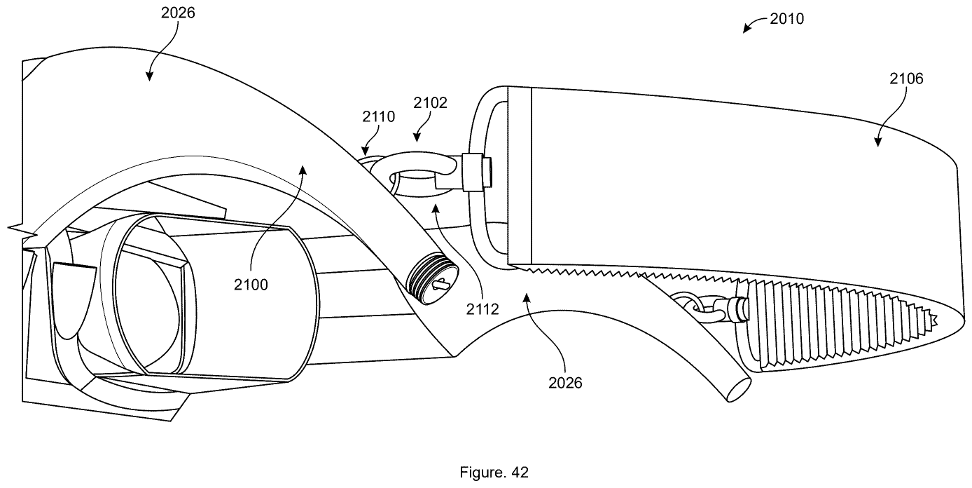

FIG. 41 shows a rear perspective view of the XR headset of FIG. 40, with a vertical head strap and audio earpieces removed; and

FIG. 42 is an enlarged perspective view of a distal end of an ear-engagement portion of the XR headset, seen in FIG. 40.

Referring firstly to FIGS. 1 to 28 of the drawings, there is shown a first embodiment of an extended reality headset, referenced globally as 10. Herein and throughout, the term extended reality is referred to as ‘XR’, which is commonly understood in the field of immersive reality technology.

The extended reality (XR) headset 10 comprises a headset body 12 which has a lens support 14, a first lens 16, and a second lens 18. A first lens cover 20 and a second lens cover 22 are supported on the headset body 12, and a front facing camera 24 is interposed between the first and second lenses 16, 18. Arm members 26 and a headset strap 28 extend rearwardly from the headset body 12, and an electronic data processor 30 along with a rechargeable onboard power source 32 are embedded in at least one of the arm members 26, either together or separately. The extended reality headset 10 is also preferably liquid-proof so the user can optionally use the XR headset 10 in an aquatic environment.

The aforementioned lens support 14 is preferably a frame, as best shown in FIGS. 1, 4 and 5, made of a lightweight material such as plastic, fiberglass or aluminium. It is feasible that any rigid and/or durable material can be used to form the lens support 14, for example, a composite plastic and/or carbon can also be used. It is also optional that the outer material of the lens support 14 could be durable and/or rigid with a soft and/or cushioned surface. Preferably, the durable and/or rigid lens support 14 has a dark non-reflective surface to prevent and/or inhibit light reflecting off the lens support 14 and into the user's eyes when the XR headset 10 is in use.

The lens support 14 in this embodiment has two spaced-apart apertures 34 into which the first lens 16 and the second lens 18 are individually received, each as a complementary fit with its respective aperture 34. The said apertures 34 are substantially rectangular with four curved corner portions, the apertures 34 extending through the lens support 14. Preferably, the first lens 16 is located on a left portion of the lens support 14 and the second lens 18 is located on a right portion of the lens support 14. It is feasible that, depending on the user's preference, the first lens 16 is located on the right portion of the lens support 14 and the second lens 18 is located on the left portion of the lens support 14.

The lens support 14 has a major upper edge 36, a major lower edge 38 and two minor side edges 40, which in this case extend preferably perpendicularly or substantially perpendicularly from respective end or end portions of the said major upper edge 36 and the said major lower edge 38. It is possible that the lens support 14 has more than one major upper edge 36 from which components of the XR headset 10 depend or extend. The major lower edge 38 may be omitted, for example, if the lenses do not require a complete lens support 14 for structural rigidity; and/or similarly one or both minor side edges 40 may be omitted if the arm members 26 extending from the lens support 14 are sufficiently narrow to allow for direct connection to the major upper edge 36 only. The major upper edge 36, the major lower edge 38 and the two minor side edges 40 are best seen in FIG. 1 and FIG. 5.

Attached to the major upper edge 36 are the first and second lens covers 20, 22, and attached to one of the minor side edges 40 and also to the major upper edge 36 is a head mounting element 42, as best seen in FIGS. 1 to 4 and 6, for example the arm members 26 and the headset strap 28 respectively. It is also feasible that the first and second lens covers 20, 22 are each attachable to discrete minor side edges 40.

Adjacently extending from the apertures 34 of the lens support 14 is a face seal 44 best seen in FIGS. 2, 3, 6, 7, 12, 13, 18 and 19. The face seal 44 extends from at least one edge of the aperture 34 to a face contact portion 46. The face contact portion 46 contacts the user's face when in use. The face seal 44 is a flexible member, preferably silicone, which prevents or inhibits liquid and/or light from entering the user's view when the XR headset 10 is worn.

The said face seal 44 therefore has the ability to suction to the user's face, specifically around the eye area to ensure an efficient seal. Due to the general shape of the user's face, each face seal 44 preferably extends unequally or non-uniformly from the aperture 34 to the face contact portion 46. A proximal portion 48a of the face seal 44, which is closest to the respective arm member 26, extends to the face contact portion 46 which is further from the aperture 34 compared to a distal portion 48b of the face seal 44, which is located furthest from the arm member 26. The face seal 44 has an outer surface 50a and an inner surface 50b, whereby the major upper edge 36 of the lens support 14 is attached to the outer surface 50a of the face seal 44 via a face seal attachment means 51, as best seen in FIGS. 2 and 18. In this embodiment, each of the face seals 44 are discretely extending from each of the apertures 34 of the lens support 14, however it is feasible that there is only one elongate face seal encompassing both apertures.

Situated on the entirety of a lens-cover facing surface 52 of the lens support 14 is a lens-cover seal 54, best seen in FIGS. 1, 4 and 5. The said lens-cover seal 54 is preferably a flexible ring, specifically in the shape of the lens-cover facing surface 52. The lens-cover facing surface 52 is preferably shaped according to the perimeter of the associated first or second lens 16, 18 and therefore according to the shape of the associated aperture 34. Therefore, the lens-cover facing surface 52 is preferably rectangular or substantially rectangular in shape with curved corners.

There are present two lens-cover seals 54 individually surrounding the first and second lenses 16, 18. Each said lens-cover seal 54 secures the first and second lens covers 20, 22 to the lens support 14. Of course, in this embodiment the second lens cover 22 is fixed to the lens support 14, however the lens-cover seal 54 is preferably present between the second lens cover 22 and the lens support 14. The first lens cover 20 contacts the lens-cover seal 54 when the first lens cover 20 is in a lens-covered position. Specifically, the lens-cover seal 54 prevents or inhibits light and/or liquid transmission between the first and second lenses 16, 18 and their respective first and second lens covers 20, 22 when the first lens cover 20 is in the lens-covered position. It is feasible that the lens-cover seal 54 is only present on the lens-cover facing surface 52 associated with the first lens cover 20 and that the second lens cover 22 is integrally formed with the lens support 14 and therefore no lens-cover seal 54 is required to be associated with the second lens cover 22. Although the lens-cover seal is suggested above, any other suitable lens-cover seal, or in other words, light prevention means, may be considered or utilised.

The first lens 16 and the second lens 18 are preferably made of a transparent material, for example, glass or transparent rigid plastic such as acrylic, for the user to view their environment while at the same time also having the ability to display augmented reality (AR) and/or mixed reality (MR). The first and second lenses 16, 18 are best viewed in FIGS. 1 and 4-6. The first and second lenses 16, 18 are located either side of a central portion 56 of the lens support 14 and therefore the first and second lenses 16, 18 are spaced apart from one another. The said first and second lenses 16, 18 each have two major surfaces 58a, through which the user views their environment, and four minor surfaces 58b, as best viewed in FIGS. 5 and 6. The first and second lenses 16, 18 are individually received within the apertures 34 of the lens support 14, and each are subsequently fixed to the lens support 14 via the four minor surfaces 58b. Due to the substantially rectangular shape of the apertures 34, the first and second lenses 16, 18 are also substantially rectangular to complementarily fit into the said apertures 34. Interposed between the first and second lenses 16, 18, and also forming part of the major upper edge 36 of the lens support 14, is the central portion 56. It is feasible that one elongate lens is present as a substitute for the first and second lenses 16, 18, the central portion 56 being interconnected to said elongate lens. Therefore, the elongate lens would be fixed into an elongate aperture 34 of the lens support 14.

It is feasible that the first and second lenses 16, 18 may be able to display VR data if the first and second lenses 16, 18 preferably have an opacity function wherein the first and/or second lenses preferably become opaque by selecting an opacity option on the menu. In this scenario, once activated, the user would not be able to see through the first and/or second lenses 16, 18, and thus VR data is preferably able to be displayed on the first and/or second lenses 16, 18.

Attached to the major upper edge 36 of the lens support 14 are the first and second lens covers 20, 22, as best seen in FIGS. 1, 3, 4, 5, 7, 10 and 11. The first and second lens covers 20, 22 are preferably formed of the same material as the lens support 14 but may also be made of a differing rigid material. For example, the lens support 14 may be made of fiberglass but the first and second lens covers 20, 22 may be made of plastic. As best shown in FIGS. 6 to 8, the first and second lens covers 20, 22 are attached to the lens support 14 via a mounting element 60. In this embodiment, the said first lens cover 20 is movable from the lens-covered position to a lens-uncovered position to therefore cover and uncover the first lens 16. The second lens cover 22 is fixed to the lens-cover facing surface 52 of the lens support 14 and therefore remains in the lens-covered position. This arrangement allows the user to experience AR, MR and/or VR data as the first and second lens covers 20, 22 are configured to display this data. It is entirely feasible that the second lens cover 22 may also be moveable, and therefore the first and second lens covers 20, 22 could be independently moveable. It is also feasible that both the first and second lens covers 20, 22 are fixed in the lens-covered position.

Mounted to the major upper edge 36 of the lens support 14 is the mounting element 60, as seen in FIGS. 1 to 13 and 15 to 18. The mounting element 60 is preferably an elongate element extending from one end of the major upper edge 36 to the other end of the major upper edge 36. The first and second lens covers 20, 22 are attached to the mounting element 60 and therefore the first and second lens covers 20, 22 are mounted to the lens support 14 via the mounting element 60. It is feasible that the first and second lens covers 20, 22 are each mounted to a discrete minor side edge 40 of the lens support 14. Preferably, the first lens cover 20 is attached to a left portion of the mounting element 60 and the second lens cover 22 is attached to a right portion of the mounting element 60. It is feasible that, depending on the user's preference, the first lens cover 20 is attached to the right portion of the mounting element 60 and the second lens cover 22 is attached to the left portion of the mounting element 60.

The aforementioned mounting element 60 further includes a first lens cover pivot element 62 which has the ability to pivotally move the first lens cover 20 into the lens-covered position and/or the lens-uncovered position. The portion of the mounting element 60 which includes the first lens cover pivot element 62 is preferably a darker colour compared to the remainder of the mounting element 60, the darker colour indicating the location of the first lens cover pivot element 62. The first lens cover pivot element 62 preferably extends the length of the first lens cover 20, the first lens cover pivot element 62 being situated within the mounting element 60. It is also feasible that the aforementioned mounting element 60 further includes a second lens cover pivot element therein which has the ability to pivotally move the second lens cover 22 into the lens-covered position and/or the lens-uncovered position.

As best seen in FIGS. 9 and 17, the first lens cover pivot element 62 includes a spring member 64 and an elongate pivot member 66 therein, resulting in a mechanical arrangement. The spring member 64 is preferably a resilient member which retains the first lens cover 20 in the lens-uncovered position and therefore one end of the spring member 64 is attached to the first lens cover pivot element 62 and the other end of the spring member 64 is attached to the mounting element 60. The spring member 64 is preferably a coiled metal spring which stores elastic potential energy to move the first lens cover 20 from the lens-covered position to the lens-uncovered position. It is feasible that in the existence of a second lens cover pivot element that it also includes a further spring member therein.

The elongate pivot member 66 is preferably a rigid metal rod extending the length of the first lens cover 20, the elongate pivot member 66 being situated within the mounting element 60. The elongate pivot member 66 is stationary as the first lens cover 20 pivots about the elongate pivot member 66 from the lens-covered position to the lens-uncovered position and vice versa. The spring member 64 is located around a spring portion 68 of the elongate pivot member 66 proximal to the central portion 56. It is feasible that the spring member 64 is located distal to the central portion 56, and therefore the spring member 64 would be proximal relative to the arm member 26. The first lens cover 20 is described as being able to move about a first lens cover pivot element 62. However, it is feasible that the lens cover may slide up to uncover the first lens 16 and slide down to cover the first lens 16 via, for example, a sliding track attached to the lens support 14. A feasible alternative of moving the first and/or second lens covers 20, 22 via the mechanical arrangement of the spring member 64 and the elongate pivot member 66 is via an electronic arrangement. The mechanical arrangement may be supplemented by an electrically operable pivot member which comprises an electric motor and an elongate drive shaft which may be electrically coupled to the first and/or second lens covers 20, 22. The electrically operable pivot member preferably enables motorized movement by clicking a button or other activation means. The electrically operable pivot member preferably enables motorized movement of the first and/or second lens covers 20, 22 into the lens covered position upon clicking the activation means.

Attached to a lens-facing surface 70 of the first and second lens cover 20, 22 is a first further lens 72 and a second further lens 74, best seen in FIGS. 1, 4, 5, 6, 8, 12 and 14. In this embodiment the first further lens 72 is preferably a Fresnel lens and the second further lens 74 is preferably a smooth lens. The first and second further lenses 72, 74 allow the user to focus on the data displayed on the first and second lens covers 20, 22. To ensure that the image displayed on a first data display element 76 is in focus for the user, a void 77 is present between the first further lens 72 and the first lens cover 20, and the void 77 is also present between the second further lens 74 and the second lens cover 22 to ensure that the image displayed on a second data display element 78 is in focus, best understood from FIG. 14 which shows one of the user's eyes viewing the data displayed on the first data display element 76 through the Fresnel lens, for example. The void 77 is preferably a gap or a slot. The Fresnel lens is present on the first lens cover 20 in this embodiment; however, it is feasible that a smooth lens can be used. Alternatively, the second further lens 74 could have a Fresnel lens instead of the smooth lens. Both the first and second further lenses 72, 74 could be the same type of lens, for example the first and second further lenses 72, 74 could both be a Fresnel lens or could both be a smooth lens. However, the Fresnel lens is preferred as it is more lightweight than the smooth lens of the same dimensions. It is feasible that several lens prescriptions are available for the user to select which lens provides them with the best focus in regard to viewing the first and second data display elements 76, 78. It is also possible that a different lens, for example a holographic or pancake lens may be utilised instead of the aforementioned Fresnel lens and the smooth lens.

Furthermore, extending perpendicularly from the lens-facing surface 70 of the first lens cover 20 is a male member 80 best seen in FIGS. 1, 7 and 8. The male member 80 is preferably a rigid protruding member tapering to a point from the lens-facing surface 70. When the first lens cover 20 is in the lens-covered position, the male member 80 is received by a female member 82 to secure the first lens cover 20 to the lens support 14 and thus counteracting the lens-uncovered position bias generated by the spring member 64. The female member 82, best seen in FIG. 1, is a recess in the lens-cover seal 54 and therefore the male and female members 80, 82 are complementary to, and releasably engageable with, one another. The complementary fit of the male and female members 80, 82 works in tandem with the lens-cover seal 54 to ensure the light and/or liquid transmission between the first lens cover 20 and the first lens 16 is prevented or inhibited. Thus, the male and female members 80, 82 form a detent system. It is feasible that instead of the male and female members 80, 82 there is a clip mechanism or a magnetic mechanism to releasably engage the first and/or second lens cover 20, 22 and the associated lens-cover seals 54. It is also optional to omit the male and female members 80, 82 when the electrically operable pivot member is utilised as the electrically operable pivot member may supplement the need of a detent system to counteract the spring bias.

Extending towards one another from the lens support 14 are two nose contact elements 84. The nose contact elements 84 specifically extend towards one another between the first and second lenses 16, 18.

The aforementioned nose contact elements 84 are located below the central portion 56 of the lens support 14 and are attached to the major lower edge 38 of the lens support 14. Preferably, the nose contact elements 84 extend from a nose contact element portion 86 of the major lower edge 38, as best seen in FIGS. 12,18 and 20. The nose contact elements 84 are preferably adjustable nose pads and have the function of supporting the lens support 14 on the bridge of the user's nose and therefore hold the lens support 14 in place. A resilient material is preferably used to form the nose contact elements 84, for example foam, plastic or even a gel inserted into a silicone outer casing, to provide a comfortable fit for the user. It is possible that there is one nose contact element 84 to connect the discrete nose contact element portion 86 of the lens support 14 to form a continuous nose contact element.

Attached to the first lens cover 20 and the second lens cover 22 is the first data display element 76 and the second data display element 78, respectively. The first and second data display elements 76, 78 are preferably display screens which have the ability to display AR, MR and/or VR data transmitted from the electronic data processor 30, as best shown by FIG. 31. In this embodiment, the first and second data display elements 76, 78 are positioned central on the respective first and second lens covers 20, 22. The display screens of said first and second data display elements 76, 78 face the respective first and second lens 16, 18 when the first and second lens covers 20, 22 are at the lens-covered position. The display screen may have, for example, an Organic Light-emitting Diode (OLED) display, a Liquid Crystal Display (LCD) or a Light-emitting Diode (LED) display.

There are two navigation buttons 88 mounted to the mounting element 60, as clearly seen in FIGS. 1 to 13 and 15 to 18. The navigation buttons 88 are each preferably in the shape of a hemisphere and are able to turn the XR headset 10 on or off via clicking and/or moving one or both of the navigation buttons 88.

Although preferably hemispherical, the navigation buttons may be a full rolling sphere or other type of button, such as a touch sensitive pad and the like. Any suitable touch-sensitive input device may be considered as a suitable button.

A first navigation button 88a is preferably associated with the first lens 16 and/or first lens cover 20 and a second navigation button 88b is preferably associated with the second lens 18 and or/the second lens cover 22, as best seen in FIGS. 5, 6, 7, 11, 12 and 13. The user may click and/or move the first and/or second navigation buttons 88a, 88b to turn the XR headset 10 on or off. Preferably, only the second navigation button 88b can be clicked to turn the XR headset 10 on and off or to select options on the menu or select and/or interact with projected objects displayed on the first and/or second lenses 16, 18 and/or the first and/or second lens covers 20, 22. The first navigation button 88a can preferably only be clicked to move the first lens cover 20 into the lens-uncovered position. Preferably, the user may be able to move a projected cursor in the menu by moving both the first and second navigation buttons 88a, 88b simultaneously. It is optional, however, that the first and second navigation buttons 88a, 88b may be clicked simultaneously to turn the XR headset 10 on or off. It is also feasible that the first and second navigation buttons 88a, 88b may be used simultaneously to select options on the menu or select and/or interact with objects displayed into the external environment. It is optional that the second navigation button 88b may be clicked to move the first lens cover 20 into the lens-uncovered position or into the lens-covered position and it is also optional that the first navigation button 88a may be clicked to move the second lens cover 22 into the lens-uncovered position or into the lens-covered position.

The first and second navigation buttons 88a, 88b are each located at discrete distal portions of the mounting element 60 relative to the central portion 56, the first and second navigation buttons 88a, 88b pointing or oriented in a direction away from the central portion 56 and away from one another. The first navigation button 88a can preferably be clicked to move the first lens cover 20 into the lens uncovered position and the first lens cover 20 is preferably manually moved by the user back into the lens covered position. By moving the first lens cover 20 manually into the lens covered position, elastic potential energy will be stored by the spring member 64 which will be released when the first lens cover 20 is moved into the lens uncovered position again. Subsequently, the male member 80 of the lens-facing surface 70 is preferably received by the female member 82 of the lens-cover seal 54 when the first and/or second lens covers 20, 22 are in the lens covered position.

It is feasible that the first and/or second navigation buttons 88a, 88b are preferably clicked to move the second lens cover 22 into the lens uncovered position and the second lens cover 22 is preferably moved manually back into the lens covered position. Of course, it is feasible that the user can manually move the first lens cover 20 into the lens-covered position and/or the lens-uncovered position without the need of the first navigation button 88a. Preferably, the first and/or second lens covers 20, 22 are able to be moved into the lens covered position and lens uncovered position by clicking the first and/or second navigation buttons 88a, 88b. Thus, the first and/or second lens covers 20, 22 may be moved via the electrically operable pivot member which preferably negates or limits the need to move the first and/or second lens covers 20, 22 manually. It is also possible that there is only one navigation button 88 which is associated with the first lens 16, the first lens cover 20, the second lens 18 and the second lens cover 22.

The navigation button 88 includes an analogue stick in communication with the electronic data processor 30, as best shown in FIG. 28, to enable the user to navigate between the AR, MR or VR data of the XR headset 10 on a menu screen 90. The menu screen 90 may be specific depending on what data is transmitted to the XR headset and therefore the menu screen 90 may also be used by the user to select various options generated by the said data. The navigation button 88 may be clickable and, due to the analogue stick being within the navigation button 88, the user can navigate the menu screen 90 with a 360° movement capability.

Positioned on the central portion 56 is the front facing camera 24, as best seen in FIGS. 1, 3, 4, 5, 10, and 11, which is preferably a round fisheye camera lens providing the user with a wide-angle 180° exterior view at, and/or in the vicinity of, the lens support 14. The wide-angle view preferably ranges between 100° to 280°.

The front facing camera 24 can be used to show the user their external environment when the first and/or second lens covers 20, 22 are covering the first and/or second lenses 16, 18, respectively. Preferably, when the first lens cover 20 is in the lens-uncovered position, the front facing camera 24 may allow the user to see their external environment displayed on the second lens cover 22. It is feasible that the front facing camera 24 is not directly attached to the central portion 56 and is instead attached to a camera support which is extending from the lens support 14 or head mounting element 42.

Attached to the central portion 56, specifically below the front facing camera 24, are two further front facing cameras 92 as best shown in FIGS. 1, 3-5, 10 and 11. The said further front facing cameras 92 are preferably the same dimensions as the front facing camera 24. The front facing camera 24 is preferably central relative to the further front facing cameras 92 attached to the central portion 56. The further front facing cameras 92 preferably have an automated zoom function. It is described that there are two further front facing cameras 92, however it is possible that only one further front facing camera 92 is attached to the central portion 56 or more than two further front facing cameras 92 are present. Additionally, as with the front facing camera 24, it is feasible that the further front facing cameras 92 are not directly attached to the central portion 56 and are instead attached to a camera support, either with the front facing camera 24 or separate to the front facing camera 24. The camera support may extend from the lens support 14 or head mounting element 42.

An environment detection means 94 is present whose function is to sense the users' surroundings when using MR and therefore provide the electronic data processor 30 with data regarding the optimal position for displaying the MR data to the user. There is a total of two environment detection means 94 as best shown in FIGS. 1, 3, 4, 5, 10 and 11, which are deposited either side of the front facing camera 24 and therefore located above each further front facing camera 92. The environment detection means 94 are preferably round or substantially round. The arrangement of the front facing camera 24, the further front facing camera 92 and the environment detection means 94 result in a cluster or collection of cameras and sensors arranged in close proximity to one another. This cluster or collection of cameras and sensors is termed an arachnid layout in this specification.

As best represented in FIG. 28, the environment detection means 94 is electrically communicable with the electronic data processor 30. The environment detection means 94 is preferably a light detection and ranging (LiDAR) scanner to determine the depth of the external environment. It is feasible that there is more than one environment detection means 94 attached to the central portion 56 depending on the user's preference to the level of accuracy required to analyze their surroundings. It is feasible that the environment detection means 94 may have thermal, night vision and/or X-ray vision abilities. It is also feasible that a further environment detection means 94 is present on the head mounting element 42, where preferably the environment detection means 94 is used to provide the electronic data processor 30 with data regarding the proximity of objects behind the user in the external environment.

Situated on the central portion 56 below each of the further front facing cameras 90 are two light emitting devices 96 as best seen in FIGS. 1, 3, 4, 5, 10 and 11. The light emitting devices 96 are situated on the central portion 56. The light emitting devices 96 preferably act as torches to illuminate the user's external environment, as best seen in use in FIG. 32. Each light emitting device 96 is situated below one of the further front facing cameras 90. The light emitting devices 96 are preferably light emitting diodes (LEDs). It is feasible that there is only one light emitting device present or that there are more than two light emitting devices 96 present. The light emitting devices 96 may feasibly be located anywhere on the headset body 12 or even on the head mounting element 42.

Extending rearwardly from the minor side edge 40 and/or the major upper edge 36 of the lens support 14 is the head mounting element 42 including the arm member 26 and/or the headset securing means 98. The head mounting element 42 allows the XR headset 10 to be mounted over the user's head and/or ears in order to keep the XR headset 10 in place over the user's eyes. It is feasible that the head mounting element 42 may be a helmet into which the XR headset 10 is set and therefore the helmet fits around the majority of the user's head.

There are two arm members 26 each extending rearwardly from discrete minor side edges 40 of the lens support, as best shown in FIGS. 1 to 13 and 15 to 19. The arm members 26 are elongate members preferably made of a lightweight material such as plastics, fiberglass or aluminium, and are preferably made of a differing material to the lens support 14. For example, the arm members 26 may be made of plastics and the lens support 14 may be made of fiberglass. It is feasible that any rigid and/or durable material can be used to form the arm members 26, for example, a composite plastics and/or carbon can also be used. It is also optional that the outer material of the arm members 26 could be durable and/or rigid with a soft and/or cushioned surface, such as an over-moulded rubber or polymer finishing layer. The arm members 26 support the XR headset 10 on the user's ears and have a curved end portion 100 to hook around the user's ears for added security, as best seen in FIGS. 2, 3, 4, 6, 8, 10, 12, 15, 16, 18 and 19. The curved end portion 100 is located at a distal end of the arm member 26 relative to the lens support 14, the curved end portion 100 curving downwardly as it hooks around the user's ear. It is of course feasible that there is no curved end portion 100 and instead the said each arm member 26 continues along the same plane. Furthermore, it is feasible that the arm members 26 are preferably made of the same material as the lens support 14 and may also be integrally formed with the lens support 14.

The arm members 26 may preferably be attached to the lens support 14 via at least one hinge 101, as best seen in FIG. 20 which omits the face seal 44 for clarity. The hinges 101 are preferably four metal elements but can also be plastics, fiberglass, or any other rigid material. One of the hinges 101 is attached to an inner face of the arm member 26, the hinge 101 being at a proximal portion of the inner face relative to the first lens 16. The hinges 101 attach the minor side edge 40 of the lens support 14 to the arm member 26. Although it is not shown, the hinge 101 is preferably also present between the proximal portion of the arm member 26 relative to the second lens 18 and the respective minor side edge 40. The hinges 101 allow the XR headset 10 to be folded about the hinges 101 for ease of storage, much like eyewear. It is feasible that there are no hinges 101 or that the hinges 101 are only present between one of the arms and the minor edge portion 40.

The headset securing means 98, as best seen in FIGS. 1, 2 and 3, is preferably at least a headset strap 28 which extends rearwardly from the major upper edge 36 of the lens support 14 and is attached to the lens support 14 via an attachment means 102, as best seen in FIGS. 2 and 3. The headset strap 28 is a resilient member which fits over and/or around the user's head and which may have a textured inner surface for enhanced grip to the user's head and therefore prevent the XR headset 10 from falling off the user's head when the user is in motion. The resilient member is preferably a durable leather strap, but it could be a durable fabric or plastic strap. The said headset strap 28 is also adjustable to the user's head size and shape via an adjustment means 104, as best seen in FIG. 2. The adjustment means 104 is preferably a metal buckle, such as aluminium, but it is also feasible that the adjustment means 104 is a plastics or metal alloy buckle.

As best shown in FIGS. 1-3, the headset strap 28 includes a horizontal strap 106 and a vertical strap 108. In this embodiment, the headset securing means 98 includes the arm member 26 and the headset strap 28. Therefore, in this embodiment the vertical strap 108 is attached to the major upper edge 36 of the lens support 14 and the horizontal strap 106 is attached to the curved end portions 100 of the arm members 26. Although horizontal and vertical straps are suggested above, any other suitable headset strap, or in other words, headset retaining strap or other retaining means, may be considered and utilised. Therefore, pliantly flexible or fabric straps or more resilient bands, head covers, helmets and the like can potentially be considered.

The attachment means 102 preferably includes a bracket element 110 and a hook element 112 which interconnect to allow the headset strap 28 to attach to the XR headset 10. The arm member 26 has a bracket element 110 attached to an upper surface of the curved end portion 100, and the major upper edge 36 of the lens support 14 also has a bracket element 110 thereon, the bracket element 110 preferably being a semi-circle or substantially a semi-circle. The bracket element 110 situated on the major upper edge 36 of the lens support 14 is preferably on the central portion 56 of the lens support 14, as best seen in FIGS. 6, 7, 8, 18 and 19. The said bracket element 110 is complementarily receivable by an associated socket embedded within the upper surface of the curved end portion 100. When the bracket element 110 is not in use, it may be pushed, and therefore stored, within the associated socket to hide the said bracket element 110. In order to further hide the bracket element 110 situated on the major upper edge 36 of the lens support 14, an associated bracket element cover is preferably provided to complementarily fit over the associated socket. It is feasible that an associated bracket element cover may be provided to complementarily fit over the associated socket of the bracket element 110 situated on the curved end portion 100. as best shown in FIG. 3. Of course, it is feasible that there is only one of either the horizontal or vertical straps 106, 108, and alternatively there may be a plurality of headset straps 28 attaching the XR headset 10 to the user's head. It is feasible that the hook element 112 may be a ring which is openable to receive the bracket element 110, the hook element 112 being subsequently closeable to interconnect the bracket element 110 and the hook element 112.

As best seen in FIG. 2, a rear facing camera 114 is mounted to the headset securing means 98, and more specifically mounted to the headset strap 28, to provide a preferable wide-angle 180° rear view of the user's exterior environment. The wide-angle view preferably ranges between 100° to 280°. The rear facing camera 114 is preferably a round or substantially round camera. The aforementioned rear facing camera 114 can be used in tandem with the front facing camera 24. The rear facing camera 114 is preferably attached to a rear facing camera portion 116 which in turn is mounted at an intersection between the horizontal and vertical straps 106, 108 of the head mounting element 42. The rear facing camera portion 116 is preferably a durable and/or rigid member preferably made of the same material as the lens support, but if the lens support 14 is made of plastic, it is feasible that the rear facing camera portion 116 is made of a different material such as fiberglass or aluminium. The rear facing camera portion 116 is best shown in FIGS. 2 and 3.

Disposed on the headset body 12 or the head mounting element 42 is the electronic data processor 30, as best seen in FIGS. 26 and 27, said electronic data processor 30 being preferably mounted onto a circuit board. In this embodiment, the electronic data processor 30 is disposed within one of the arm members 26. The electronic data processor 30 can also alternatively be disposed within the head mounting element 42. The said electronic data processor 30 is configured to generate AR, MR and/or VR data for the user to experience. The said electronic data processor 30 therefore has the ability to output said AR and/or MR data to at least one of the first and second lenses 16, 18 and/or output said AR, MR and/or VR data to at least one of the first and second lens covers 20, 22.

Preferably, the electronic data processor 30 is in communication with conductive, isolating and transmissive material, preferably conductive wires, to be in electrical communication with some of the features of the XR headset 10, the wired connection being best shown visually in FIG. 28 where the wires are represented by the connecting lines for simplicity.

The electronic data processor 30 has the ability to wirelessly communicate with a further user's XR headset 10 utilizing a short-range wireless-data transceiver 118, as best shown in phantom in FIGS. 26 and 27 and in use in FIG. 34, and therefore one user can experience the same AR, MR and/or VR data as the further user. How the electronic data processor 30 is in electrical communication with various features of the XR headset 10 is set out in FIG. 28. It is feasible that there are two or more than two electronic data processors 30 located within one of the arm members 26 or that the two or more than two electronic data processors 30 are locatable in both of the arm members 26.

The electronic data processor 30 of the headset body 12 is in communication with, and therefore relays electronic signals to a digital projector 120, as represented by the block diagram of FIG. 28. The digital projector 120 is at or adjacent to the first and/or second lenses 16, 18 to project AR and/or MR digital media onto the first and/or second lens 16, 18, as best seen in FIGS. 6 and 12 and in use in FIG. 31. The digital projector 120 is preferably attached at or adjacent to an internal surface of the face seal 44 so that the user can focus on the data displayed on the first and/or second lens 16, 18. It is feasible that the digital projector 120 instead projects the images directly onto the user's retina. There may also be more than one digital projector 120, especially if the second lens cover 22 is moveable about the second lens cover pivot element and therefore the user can view the external environment directly through the second lens 18.

A switching element 122, as best seen in FIGS. 4 and 5, is preferably a sensor provided to indicate to the electronic data processor 30 whether to activate the digital projector 120 and/or the first data display element 76 of the first lens cover 20. The switching element 122 is therefore also associated with the movement of the first lens cover 20 from the lens-covered position to the lens-uncovered position. Subsequently, the lens-covered position of the first lens cover 20 activates the first data display element 76 as the switching element 122 relays data to the electronic data processor 30, and therefore electronically communicating that the first lens cover 20 is covering the first lens. FIG. 28 shows a simplified representation of the switching element 122 being in electrical communication with the electronic data processor 30. When the first lens cover 20 moves to the lens-uncovered position, the digital projector 120 is activated via the switching element 122 sensing the subsequent movement.

An eye tracking sensor 123 is preferably attached at or adjacent to the internal surface of the face seal 44, as best shown in FIGS. 6, 12 and 31. The eye tracking sensor 123 preferably track's the users eye movement when the XR headset 10 is activated. For example, when two users are using discrete XR headsets 10, whether they are viewing AR, MR or VR data, the eye movement of each user is detected by the eye tracking sensor 123 to preferably display corresponding data to the users, where the data displayed is in the same relative position in a common environment for both of the users.

It is also possible that the eye tracking sensor 123 of one of the XR headsets 10 may display where the other user is located using the eye tracking sensor 123 of the further XR headset 10.

The user may also be able to navigate the menu screen 90 by moving their eyes when the menu screen 90 is open, and therefore the eye tracking sensor 123 may be able to track what option the user would like to select based on what option the user is focussing on.

The onboard power source 32 is preferably one or more battery cells which provides the electronic data processor 30 and subsequently the XR headset 10 with power to function. In this embodiment, the onboard power source 32 may be for example rechargeable battery cells which can be charged via a charging port. The onboard power source 32 may be, for example, a solid-state battery, an alkaline battery or more preferably a rechargeable battery such as a nickel metal hydride battery or a lithium-ion battery.

A charging port 124 is situated at a distal portion of the arm member 26 relative to the lens support 14, the arm member 26 extending from a portion of the lens support 14 proximal to the first lens 16. The aforementioned charging port 124 is best seen in FIGS. 6, 12 and 19. In this embodiment the charging port 124 is preferably a socket into which a cable can be plugged to provide power to the onboard power source 32. The charging port 124 also preferably includes a screw thread situated on an outer surface of the charging port 124 to engage with the cable more efficiently. Therefore, the cable preferably has an internal screw thread to engage screw-threadingly with the charging port 124.

Associated with the charging port 124 is a charging port cover 128, as best shown in FIG. 18, to cover the charging port 124 when the charging port 124 is not in use and/or when the user would like to use the XR headset 10 in an aquatic environment to prevent liquid entering the charging port 124. The charging port cover 128 complementarily fits over the charging port 124, and therefore the charging port cover 128 has an internal screw thread to screw threadingly engage the charging port 124. The charging port cover 128 is preferably a cap or a sheath and is preferably made of a rigid material such as plastic or fiberglass. It is feasible that the charging port cover 128 is made of a resilient material such as flexible plastic or silicone.

Disposed within the headset body 12, and associated with the electronic data processor 30, is the short-range wireless-data transceiver 118 as best shown in FIGS. 26 and 27. The short-range wireless-data transceiver 118 may be for example a Bluetooth (RTM) device or an NFC (RTM) device, but both may feasibly be present. The short-range wireless-data transceiver 118 preferably transmits and receives radio data from a server 130 to the XR headset 10, and predominantly indicates to the electronic data processor 30 what data should be displayed on the first and second lenses 16, 18 and/or the first and second lens covers 20, 22. For example, the short-range wireless-data transceiver 118 can receive and transmit data from the server 130 which has loaded, for example-perhaps-, a video game. Any other suitable data may be transmitted such as educational data or workplace data which can be loaded by the server 130 and transmitted to the short-range wireless-data transceiver 118. It is feasible that the short-range wireless-data transceiver 118 may also receive data from a further or a plurality of devices which each include at least one secondary short-range wireless-data transceiver. For example, one or each of the plurality of devices may be a drone, a smart watch, a smart phone or any other suitable electronic device which transmits data via its secondary short-range wireless-data transceiver to the short-range wireless-data transceiver 118 of the XR headset 10. In order to enhance the range of the short-range wireless-data transceiver 118, an antenna may extend from and/or within the headset body 12, and it may be possible that a short-range wireless-data transceiver 118 is attachable to the antenna.

Although it has been described that the short-range wireless-data transceiver 118 is preferably for use with the server 130, the short-range wireless-data transceiver 118 and/or a further wireless-data transceiver may have longer range data transmission. For example, the or a transceiver may be able to communicate using 5G (RTM) and/or Wi-Fi (RTM) signals to a longer-range server or suitable electronic device, such as neighboring like headset or headsets and/or mobile telecommunications devices, and therefore appropriate electronic modules may be added to the or each XR headset 10.

The XR headset 10 is preferably wirelessly communicable with the server 130, best shown by the diagram in FIG. 34. The server 130 loads data and transmits the said data to the short-range wireless-data transceiver 118 which in turn transmits the data to the electronic data processor 30 which communicates the data to be projected via the digital projector 120 onto the first and/or second lens 16, 18 or the data is displayed on the first and/or second data display elements 76, 78. Any data generated by the user is transmitted back to the server 130 via the short-range wireless-data transceiver 118.

A microphone 132 is preferably located on, and therefore integrated with, the headset body 12 or the head mounting element 42 to enable an audio input to be received from the user, as best shown in FIGS. 1, 4, 8, 16 and 18. The microphone 132 is embedded into the headset body 12 and/or the head mounting element 42 and is located proximally to the lens support 14 in order to effectively receive audio spoken by the user. The aforementioned microphone 132 is round or substantially round. The microphone 132 of the user can therefore be used to relay voice commands to the electronic data processor 30 and/or for the user to communicate to other users utilizing a separate XR headset 10. The audio data is preferably transmitted to the separate XR headset 10, or other suitable electronic device, via the short-range wireless-data transceiver 118 and/or other transceiver as mentioned above. The microphone 132 preferably has an external-noise cancellation element which ensures or assists the user to be heard clearly when they speak into the microphone 132. The user can preferably access the menu screen 90 and select which level of noise cancellation they would prefer, for example, if the user would like the external noise to be received by the microphone 132, then the user can turn off the external-noise cancellation element. It is feasible that the microphone 132 may extend from the headset body 12 to the user's mouth. It is also feasible that the microphone 132 is integrated with a speaker 134. It is feasible that there may be more than one microphone 132 located on or integrated with the headset body 12 and/or the head mounting element 42. If there is more than one microphone 132, it is feasible that one microphone 132 is located on the headset body 12 and the other microphone 132 is located on the head mounting element 42, and therefore the microphones 132 are located on different portions of the XR headset 10.

The speaker 134 is preferably located on the headset body 12 and/or the head mounting element 42 and outputs an audio signal to the user. The speaker 134 includes a pair of audio earpieces 136 which fit in or around the user's ears to prevent or inhibit the audio entering the user's external surroundings, as best shown in FIGS. 21 to 25. The pair of audio earpieces 136 are preferably separate to the headset body 12 but it is feasible that each of the pair of audio earpieces 136 are attachable to discrete arm members 26. The said pair of audio earpieces 136 each include an earpiece body 138 and an earpiece securing means 140. The earpiece securing means 140 is preferably a flexible hook which extends from the earpiece body 138 and hooks around the back of the user's outer ear to secure the earpiece to the user's ear. The earpiece securing means 140 is preferably made of a flexible resilient material such as flexible plastic or silicone.

The earpiece body 138 is preferably formed of two convex disks adjoined by their respective circumferences, the said earpiece body 138 being preferably made of the same material as the lens support 14 and arm members 26. Therefore, the earpiece body 138 is preferably made of a durable rigid material such as plastic, fiberglass or aluminium and preferably has a soft and/or cushioned surface. Situated on the surface of one of the convex disks is preferably a grippable portion 142 wherein four cone members 144 are interconnected via their points to form an ‘X’ shape to provide the user with an enhanced grip as best shown in FIG. 21. At the junction of the ‘X’ is preferably a further light emitting device 146, best shown in FIGS. 21 to 25, which indicates when the audio earpieces 136 are on, off, whether or not they are connected to the short-range wireless-data transceiver 118 and/or whether an audio earpiece onboard power source 148 is low on charge. The audio earpiece onboard power source 148 is shown in phantom in FIG. 22. In order for the audio earpieces 136 to connect to the XR headset 10 wirelessly, the audio earpieces 136 preferably contain a further short-range wireless-data transceiver 150, best shown in phantom in FIG. 22, in communication with the short-range wireless-data transceiver 118 of the XR headset 10.

Further navigation buttons 152 may each be situated on a distal portion of each of the cone members 144, relative to the further light emitting device 146, as best seen in FIGS. 21 to 25, so that the user can navigate the menu screen 90 of the XR headset 10.

The menu screen 90 preferably includes a further menu screen 151 which, for example, may only be accessible using the further navigation buttons 152. The user can preferably utilise the further menu screen 151 to select an audio function and/or calling function, so that the user may be able to communicate with further users. The audio earpieces 136 would therefore typically have appropriate electronic modules to enable activation of the audio function and/or the calling function.

Situated on the opposing convex disk is an ear interaction means 154, as best seen in FIGS. 22 to 25. Preferably, the ear interaction means 154 is an earpiece tip which fits into the entrance of the user's ear canal. The ear interaction means 154 is optionally a flexible member made of flexible plastic or silicone. Audio exits the audio earpieces 136 via the ear interaction means 154 so therefore the audio is subsequently directed into the user's ear canal.

The said pair of audio earpieces 136 are preferably noise cancelling and also may have a built-in microphone 132 preferably located on the grippable portion 142 of the earpiece body 138. It is feasible that the pair of audio earpieces 136 do not have an earpiece securing means 140 and instead the earpiece body 138 is shaped to complementarity fit into the user's ear. Furthermore, it is feasible that the microphone 132 is located on the grippable portion 142.

The speaker 134 and/or the audio earpieces 136 can be used to relay audio to the user from the server 130 and/or audio from other users utilizing a separate XR headset 10. It is feasible that the speaker 134 is a pair of integrated headphones which are integrally formed with the headset body 12 and/or the head mounting element 42.

A vibration element 156 may be present within the headset body 12 to provide the user with haptic feedback depending on the data transmitted to the short-range wireless-data transceiver 118. The vibration element 156 may be a rumble motor which, when activated by the electronic data processer 30, vibrates according to the data transmitted. There is preferably at least one vibration element 156 within each of the arm members 26, as best seen in phantom in FIGS. 26, 27 and 34, and there is preferably at least one vibration element 156 within the lens support 14, as best shown in phantom in FIGS. 26, 27 and 34.

An indicator element 158 is present on an opposing surface of the first and/or second lens covers 20, 22 to the lens-facing surface 70, as best viewed in FIGS. 1, 3, 4, 5, 10 and 11. The indicator element 158 preferably includes six light emitting elements, which in this case are preferably Light emitting Diode (LED) devices. These indicate to the user if the XR headset 10 is on, off, whether the onboard power source 32 has high charge and/or whether the onboard power source 32 has low charge. For example, if the onboard power source 32 has high charge, all six of the light emitting elements will preferably be activated, and if the onboard power source 32 has low charge, then preferably less than six of the light emitting elements will be activated.

The indicator element 158 is activated if the XR headset 10 is turned on and if the onboard power source 32 has high charge, therefore the indicator element 158 is in electrical communication with the electronic data processor 30.

Furthermore, the indicator element 158 may indicate whether the short-range wireless-data transceiver 118 is in communication with the server 130, a secondary device containing a secondary short-range wireless-data transceiver, for example a drone, smart watch, smart phone, or other suitable electronic device, and/or with a further user's XR headset 10. If the short-range wireless-data transceiver 118 is in communication with the server 130, the indicator element 158 is activated.

It is feasible that the indicator element 158 projects a variety of colours. For example, the indicator element 158 may appear red if the onboard power source 32 has low charge.

It is also feasible that there may be more than six or less than six light emitting elements, as necessity dictates.

It is feasible that the XR headset 10 is associated with an Artificial Intelligence (referred to as AI) system which is in communication with the electronic data processor 30. The AI system has the ability to instruct the user about how to use the XR headset 10.

Referring to FIGS. 29 to 39, there is shown the first embodiment of the extended reality headset 10 in use.

Firstly, the user places the XR headset 10 onto their head, with the first lens cover 20 in the lens-covered position. The head mounting element 42, specifically the headset strap 28 and the arm members 26, are fitted over the user's head and onto the user's ears respectively. The horizontal and vertical straps 106, 108 are also adjusted, using the adjustment means 104, to fit the user's head.

The XR headset 10 is then turned on using either or both of the first and/or second navigation buttons 88a, 88b. The onboard power source 32, which for example is one or more battery cells, provides power to the device and therefore the user can use the XR headset 10 without being connected to a mains power supply as long as the onboard power source 32 has suitable charge.

The user inserts the pair of audio earpieces 136 into their ears. The ear interaction means 154 is received by the entrance of the user's ear canal, and the earpiece securing means 140 is hooked around the back of the user's outer ear. The audio earpieces 136 are then turned on utilizing the further navigation buttons 152 and subsequently the further short-range wireless-data transceiver 150 wirelessly connects to the short-range wireless-data transceiver 118 of the XR headset 10.

As best shown in FIG. 29, if the user wants to use the XR headset 10 as the onboard power source 32 is charging, an external battery pack 162 is releasably connectable to the XR headset 10 via the charging port 124. The external battery pack 162, preferably having an external battery indicator element 163, further comprises an external battery pack connection cable 164 to connect the external battery pack 162 to the charging port 124. There are preferably six external battery indicator elements 163, as best seen in FIG. 30, which are preferably six light emitting elements, which are preferably Light emitting Diode (LED) devices. These indicate to the user if the external battery pack 162 is on, off, whether the external battery pack 162 has high charge and/or whether the external battery pack 162 has low charge. For example, if the external battery pack 162 has high charge, all six of the light emitting elements will preferably be activated, and if the external battery pack 162 has low charge, then preferably less than six of the light emitting elements will be activated.

Alternatively, the user can connect the XR headset 10 directly to a mains power source via a mains connection cable. It is also feasible that the user can charge the onboard power source 32 of the XR headset 10 via a wireless charging means, for example through the use of electromagnetic induction.

It is feasible that there may be more than six or less than six light emitting elements, as necessity dictates.

Once the XR headset 10 is turned on using either or both of the first and/or second navigation buttons 88a, 88b, the menu screen 90 appears on the first and/or second data display screens of the first and/or second lens covers 20, 22. The user can use the first and/or second navigation buttons 88a, 88b to navigate the menu screen 90 and select between using AR, MR or VR data. The AR, MR and VR data is transferred to the electronic data processor 30 via the short-range wireless-data transceiver 118. The short-range wireless-data transceiver 118 receives wireless data from the server 130, into which data has been loaded. This transmission of data is represented visually in FIG. 34.

When the first lens cover 20 is in the lens-covered position, VR data is displayable on both the first and second data display elements 76, 78. For an enhanced experience, the user either activates the speaker 134 using the navigation buttons 88 or places the pair of audio earpieces 136 into each of the user's ears to provide the user with the audio output.

The user can also experience AR and/or MR while the first lens cover 20 is in the lens-covered position. This is made possible by the front facing camera 24 and the environment detection means 94 collecting data from the user's external surroundings. The further front facing cameras 92 allow the user to zoom into features present in the AR and/or MR environment, and also preferably being able to zoom into the features present in the external environment, the zoom function being accessible using the navigation buttons 88. The environment detection means 94 provides the electronic data processor 30 of the XR headset 10 with data regarding the optimal position for displaying the MR data to the user as the position of the external surroundings are identified. The user can also activate the rear facing camera 114, shown in FIG. 33, using the first and/or second navigation buttons 88a, 88b. The view from the rear facing camera 114 is preferably displayed to the entirety of or a section of the first and/or second lenses 16, 18 and/or the first and/or second data display elements 76, 78 and shows the user what is behind them.

If the user would like to view the external surroundings without the use of the front facing camera 24, the user clicks the first navigation button 88a to activate the first lens cover 20 to move into the lens-uncovered position. The female member 82, located on the lens-cover seal 54, releases the male member 80, extending adjacent to the lens-facing surface 70, to allow the first lens cover 20 to move.

The first lens cover 20 moves about the first lens cover pivot element 62 to the lens-uncovered position. Specifically, the elongate pivot member 66 within the first lens cover pivot element 62 is the point at which the first lens cover 20 pivots about. The spring member 64 stored elastic potential energy when the first lens cover 20 was in the lens-covered position and so as the spring converts the elastic potential energy to kinetic energy the first lens cover 20 moves to the lens-uncovered position.

As represented in FIG. 31, the first lens 16 has the ability to display AR and MR data being projected from the digital projector 120. The environment detection means 94 detects the user's external surroundings and provides the electronic data processor 30 with data regarding the optimal position for displaying the MR data to the user on the first lens 16. As the second lens cover 22 is fixed to the lens support 14, AR and MR data can still be displayed on the second lens 18, however in order to incorporate the user's surroundings, the front facing camera 24 must be used to display the external environment data onto the second data display element 78.

When the first lens cover 20 is in the lens-uncovered position, the user can still decide to continue experiencing VR data on the second lens cover 22 and can navigate with both the first and second navigation buttons 88a, 88b while one of the first and second navigation buttons 88a, 88b will only be able to scroll up and down and the other forward, backwards, left and right in a VR/AR/MR experience. Only the second navigation button 88b may be used to select which data the user would like to experience by selecting AR, MR or VR data by pressing the second navigation button 88b. The first navigation button 88a will only preferably be pressed for moving the first lens cover 20 into the lens-uncovered position. It is of course feasible that the first and second navigation buttons 88a, 88b may be used alternatively for selecting different options. Also, when the first lens cover 20 is in the lens-uncovered position and the second lens cover 22 is in the lens-covered position, when activating VR data on the second lens cover 22, the user can also decide to project that same VR data to the first lens 16 in sync. As the digital projector 120 will project the synced data to the first lens 16, the data viewed will be viewed as AR data due to the transparency of the first lens 16 and then of course also with the MR touch involved synchronically. Therefore, the user will be able to use both the first and second navigation buttons 88a, 88b to navigate synchronically between both first and second lenses 16, 18 and/or first and second lens covers 20, 22 and decide whether or not to extend the data over to the first lens 16 when in the lens-uncovered position. When both the first and second lens covers 20, 22 are in the lens-covered position, preferably the AR, MR or VR data will be synchronised, between the first and second data display elements 76, 78 preferably when using the first and second navigation buttons 88a, 88b.

If the user is in a dark environment, they can activate the light emitting device 96 to illuminate their external surroundings, as best seen in FIG. 32. The user can activate the light emitting device 96 using the first and/or second navigation buttons 88a, 88b. The user can activate the light emitting device 96 whether the first lens cover 20 is in the lens-covered or lens-uncovered position.

Once the user has finished experiencing AR, MR and/or VR data, the user turns the XR headset 10 off using the first and/or second navigation buttons 88a, 88b. Therefore, the short-range wireless-data transceiver 118 stops receiving data from the server 130 and AR, MR or VR data are no longer displayed on the first and/or second lens 16, 18 or first and/or second data display elements 76, 78.

FIGS. 35 to 39 show a number of examples of how the user can use the XR headset 10, with the head mounting element 42 and pair of audio earpieces 136 omitted for clarity. It should be taken into account that the XR headset 10 can be used without either of these omitted features, however the description hereinafter will assume that they are present in FIGS. 35 to 39.

FIG. 35 represents a first example where the user has the first lens cover 20 in the lens-covered position, and therefore uses the front facing camera 24 to identify the user's external surroundings when generating AR and/or MR data onto the first and/or second data display elements 76, 78. A customer is present who shows the user data on their portable device. For example, the customer may have a machine-readable optical label present, preferably a QR code or barcode, on their portable device for the user to scan. The user can use the front facing camera 24 and/or the further front facing camera 92 to identify and/or scan the machine-readable optical label to allow the customer into an event, for example. This example shows that the use of XR headsets 10 to validate machine-readable optical labels reduces the time and effort spent by the users, preferably employees, and therefore increases the efficiency of the event entry. It may be considered that the XR headset 10 is a portable workstation in this example, and therefore the users will be able to monitor their completed or pending work, navigate through guidelines of their associated company and collaborate with the company all while wearing the XR headset 10.

A second example is presented in FIGS. 36 and 37, showing a plurality of XR headsets 10 and a plurality of users each using a discrete XR headset 10.

In FIG. 36, each of the short-range wireless-data transceivers 118 of XR headsets 10 are in communication with one server 130, which allows the XR headsets 10, and therefore the plurality of users to experience the same AR and/or MR data on the first and/or second data display elements 76, 78, which in this example is a representation of planet Earth. The communication between the XR headsets 10 enables an educator, such as a teacher, to guide and impart knowledge to the further users, who are preferably students. The immersive experience encourages the students to learn more efficiently and also reduces the use of other classroom objects such as textbooks and whiteboards. The front facing camera 24 is utilised here to allow the user to view the external surroundings while the first lens cover 20 is in the lens-covered position. The users may also utilise the rear facing camera 114 to view anything displayed behind them in their external surroundings, for example, an information display board. If the students and/or teacher would like to view their external surroundings without the use of the front facing camera 24, they need only move the first lens cover 20 to the lens-uncovered position. When the first lens cover 20 is in the lens-uncovered position, the students and the teacher can continue their lesson by viewing the external environment through the first lenses. Of course, when the first lens cover 20 is in the lens-uncovered position, it is possible that AR and/or MR data is projected onto the first lens. At the same time, VR, AR and/or MR data may be displayed on the second data display element 78. Furthermore, when the first lens cover 20 is in the lens-uncovered position, preferably the VR data on the second data display element 78 is simultaneously projected onto the first lens in the form of AR/MR data, and therefore the data displayed on both the second data display element 78 and the first lens 16 is in sync.

The educational environment of FIG. 36 may take place in at least one interactive classroom which is specifically dimensioned to support lessons taken using the XR headsets 10, including at least one external motion tracker of which all different classes will switch and share in shifts for those particular subjects in their lessons for which you will need as much detailed information coming out of the XR headset 10. Optionally, instead of students sharing one interactive classroom specifically dimensioned to support lessons taken using XR headsets 10, further interactive classrooms in the same building could be equipped with that same technology so that the students in one classroom may be able to interact with the students in another classroom. This may preferably utilise the interaction between the at least two XR headsets 10 via their respective short-range wireless-data transceivers 118 and thus the students may be able to experience the same AR, MR or VR data in different interactive classrooms.

As in FIG. 36, FIG. 37 indicates that each of the electronic data processors 30 of XR headsets 10 are in communication with one server 130, which allows the XR headsets 10, and therefore the plurality of users to experience the same VR, AR and/or MR data on the first and/or second data display elements 76, 78, which in this example is a representation of a vehicle in industry. The plurality of users, preferably employees of a company, will be able to all view the same projected image and work on problems together by interacting with the projected image. The front facing camera 24 is utilised here to allow the users to view the external surroundings while the first lens cover 20 is in the lens-covered position. As VR data may be projected onto the first and second data display elements 76, 78, the front facing camera 24 may not be utilised in the scenario when the users are experiencing VR data. This means that the users can utilise XR headsets 10 for educational reasons or in the workplace. The users may also utilise the rear facing camera 114 to view anything displayed behind them in their external surroundings, for example, an information display board. If the employees would like to view their external surroundings without the use of the front facing camera 24, they need only move the first lens cover 20 to the lens-uncovered position. When the first lens cover 20 is in the lens-uncovered position, the employees can continue their work by viewing the external environment through the first lens 16. Of course, when the first lens cover 20 is in the lens-uncovered position, it is possible that AR and/or MR data is projected onto the first lens 16. At the same time, AR, VR and/or MR data may be displayed on the second data display element 78. Much like the example in FIG. 36, the workspace can be provided with an interactive room in which the employees undertake their work.

A third example is presented in FIG. 38 where a user is in an outdoor environment and the XR headset 10 displays AR and/or MR data on the first and/or second data display elements 76, 78. This representation shows that the XR headset 10 can be used in an outdoor environment as long as the short-range wireless-data transceiver 118 is in communication with the server 130. The environment detection means 94 is utilised to distinguish the depth of the user's external surroundings which therefore results in the displayed image, in this case a boulder, being displayed relative to the external surroundings. This example therefore shows the benefit of the environment detection means 94 in home renovation situations, as this example shows an example of the user utilizing AR, MR and/or VR to insert and adjust the position of a projected object in the user's garden. This will allow the user to determine where exactly they would like to place the real object of furniture in their external environment. This prevents or inhibits the user from buying a piece of furniture, bringing it home and then realizing that the furniture does not fit and/or it does not match their ideal aesthetic. Similar to FIGS. 36 and 37, the first lens cover 20 is in the lens-covered position and therefore the front facing camera 24 is in use to display the user's surroundings onto the first and/or second data display elements 76, 78. According to the example shown in FIG. 38, it is possible that the XR headset 10 may even display blueprints for the home and provide on-screen measurements for the area the user would like to place an item of furniture in. The projected object can be adjusted and moved around using the navigation buttons 88, and alternatively the user can move their head to move the projected image or use the eye tracking sensor 123 to move the said projected image. Furthermore, the user can record the data generated by the XR headset 10 and transmit the recorded data to contractors and/or builders so they are able to view exactly where the user would like the real object placed.

A fourth example is shown in FIG. 39 where VR data is displayed onto the first and/or second data display elements 76, 78 of the first and/or second lens covers 20, 22 respectively. The VR data is virtual, so therefore the image of the buildings shown in FIG. 38 is not actually in front of the user, it just appears as though it is in front of the user as the VR data is displayed on the first and/or second data display elements 76, 78 in sync. Preferably, the user is a construction worker and utilises the XR headset 10 to envisage the construction of a building and therefore what elements are needed to do so. The VR data can preferably also generate a blueprint onto which the dimensions of the construction project can be projected. If the construction worker would like to view their external surroundings to check their bearings, they need only move the first lens cover 20 to the lens-uncovered position, so therefore the user can view their external surroundings through the first lens 16. Of course, when the first lens cover 20 is in the lens-uncovered position, it is possible that AR and/or MR data is projected onto the first lens 16. At the same time, AR, MR and/or VR data may be displayed on the second data display element 78, the data on the second data display element 78 being synchronised with the data projected onto the first lens 16.

Referring to FIG. 40, there is shown a second embodiment of the extended reality headset 1010. Identical or similar features to the first embodiment have been omitted for simplicity.

There is no rear facing camera present in the second embodiment, so therefore the user can only view the external surroundings that are directly in front of them using the first lens 1016 and/or the first and second data display elements 1176, 1178. FIG. 40 best shows the horizontal and vertical straps 1106, 1108 intersecting at an intersection portion 1166. Although there is no rear facing camera and no audio earpieces present in the drawings of the second embodiment, they may be provided.

FIGS. 41 and 42 show a third embodiment of the extended reality headset 2010. Identical or similar features to the first embodiment have been omitted for simplicity.

Although there is no rear facing camera and no audio earpieces present in the drawings of the third embodiment, they may be provided. FIGS. 41 and 42 best show how the extended reality headset 2010 can be utilised using only a horizontal strap 2106 attached to the arm member 2026 via the attachment means 2102. It can be clearly viewed here that the attachment means 2102 includes at least the bracket element 2110 and the hook element 2112. The arm member 2026 has a bracket element 2110 attached to the curved end portion 2100. The horizontal strap 2106 has a hook element 2112 at associated end portions to allow the horizontal strap 2106 to connect the arm members 2026.

Herein and throughout, the extended reality (XR) headset may be considered a ‘smart’ device. As such, although communicable with the internet, it may also form part of the Internet of Things or IoT. As such, it may be individually addressable and therefore contactable when in communication with a suitable network by other like headsets, but also other physical devices with suitable sensors, software, and processing ability. This is convenient in allowing machine learning, automation, particularly in the business environment, but also in the ‘smart home’ domestic setting. Consequently, the XR headset may communicate with other common internet-enabled smart objects, such as lighting fixtures, thermostats, security system, cameras, kitchen appliances, entertainment, and healthcare systems, by way of non-limiting examples only.

It is therefore possible to provide an extended reality headset which is able to output AR, MR and/or VR data onto to at least one of the first and second lenses, and/or to output said AR, MR and/or VR data to at least one of the first and second lens covers. The user is able to choose between which data they would like to experience and can also move the first lens cover into the lens-uncovered position to view their external surroundings without having to remove the XR headset from their head. It is also possible to provide an XR headset with a front facing camera and a rear facing camera to allow the user to experience a full 360° view of their external surroundings when they are using AR and/or MR data.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. An extended reality (XR) headset for experiencing virtual reality (VR), augmented reality (AR) and mixed reality (MR), the extended reality headset comprising:
a headset body including:
a lens support;
a first lens and a second lens which are supported by the lens support and which are configured to display AR and MR thereon;
a first lens cover and a second lens cover, at least one of the first and second lens covers being movable so as to cover the corresponding said first or second lens, the first and the second lens covers including first and second data display elements, respectively, which display AR, MR and VR thereon; and
a front facing camera located at or adjacent to a central portion of the lens support to receive a view of at least one of the environment at and in the vicinity of an exterior of the lens support;
a head mounting element extending from the headset body; and
an electronic data processor on at least one of the headset body and the head mounting element, the electronic data processor generating at least any one of AR, MR and VR data, and to output at least any one of said AR and MR data to at least one of the first and second lenses, and to output at least any one of said AR, MR and VR data to at least one of the first and second lens covers.

2. The extended reality headset as claimed in claim 1, wherein the first and second lens covers have a first further lens and a second further lens, respectively, which enable a user to focus on the data displayed on the said first and second data display elements.

3. The extended reality headset as claimed in claim 1, wherein the head mounting element includes a rear facing camera attached to a rear-facing camera portion mounted at an intersection between first and second headset retaining straps.

4. The extended reality headset as claimed in claim 1, further comprising at least one lens-cover light-seal at the lens support which prevents or inhibits light transmission between the first and second lenses and the respective first and second lens covers.

5. The extended reality headset as claimed in claim 1, wherein the second lens cover is fixed to a lens-cover facing surface of the lens support.

6. The extended reality headset as claimed in claim 1, wherein the lens support further includes a mounting element onto which the first and second lens covers are mounted.

7. The extended reality headset as claimed in claim 6, wherein the mounting element further includes a first lens-cover pivot element by which the first lens cover is pivotably mounted to the lens support.

8. The extended reality headset as claimed in claim 1, further comprising a first navigation button associated with at least any one of the first lens and first lens cover, and a second navigation button associated with at least any one of the second lens and the second lens cover, the first and second navigation buttons enabling navigation between at least any one of AR, MIR and VR data.

9. The extended reality headset as claimed in claim 1, wherein the lens support comprises at least one further front facing camera with an automated zoom function.

10. The extended reality headset as claimed in claim 1, wherein the headset body further comprises at least one digital projector which is configured to communicate with the electronic data processor, the digital projector configured to project at least any one of AR and MR digital media onto at least one of the first and second lenses.

11. The extended reality headset as claimed in claim 10, wherein the digital projector and the data display element are individually or jointly activated via a switching element.

12. The extended reality headset as claimed in claim 11, wherein the first lens cover has a lens-covered position and a lens-uncovered position to respectfully cover and uncover the first lens, the lens-covered position activating at least the associated data display element via the switching element, and the lens-uncovered position activating at least the digital projector via the associated switching element.

13. The extended reality headset as claimed in claim 1, wherein the head mounting element is at least in part an arm element which can be rested on a user's ear to support the headset body on a face of a user.

14. The extended reality headset as claimed in claim 1, further comprising at least one microphone configured to receive an audio input and at least one speaker forming part of an audio earpiece outputting an audio signal.

15. The extended reality headset as claimed in claim 1, further comprising a charging port which connects to an onboard power source of the extended reality headset.

16. The extended reality headset as claimed in claim 1, further comprising a short-range wireless-data transceiver which is associated with the electronic data processor.

17. The extended reality (XR) headset system comprising an extended reality (XR) headset as claimed in claim 1, and a server, the extended reality headset being configured to wirelessly communicate with the said server.

18. An extended reality (XR) headset apparatus comprising an extended reality (XR) headset as claimed in claim 1, and an external battery pack which is configured to releasably connect to the extended reality headset to charge an onboard power source.

19. An extended reality (XR) headset system for experiencing virtual reality (VR), augmented reality (AR) and mixed reality (MR), the extended reality headset system being data-communicable with a pair of audio earpieces, the extended reality headset system comprising:
a liquid proof headset body including:
a first lens and a second lens configured to display AR and MR thereon;
a lens support to which is mounted the first lens and the second lens thereon so as to be spaced apart by a central portion having at least one light emitting device and at least one nose contact element and at least one front camera;
a front facing fish-eye camera located at or adjacent to the central portion of the headset body, the front facing fish-eye camera being configured to display a real world view;
a first lens cover and a second lens cover, at least one of the first and second lens covers being movable via a pivot element so as to cover the corresponding said first lens or second lens, the first and the second lens covers being configured to display AR, MR and VR thereon;
a lens-cover seal mounted on the lens support, the lens-cover seal surrounding the first and second lenses;
a navigation button being located on the or each said pivot element respectively;
a short-range wireless transceiver;
a microphone;
at least one speaker;
a charging port;
a charging port cover configured to connect to the charging port;
a head mounting element extending from the headset body, the head mounting element configured to attach to the lens support via at least one bracket member and at least one ring member;
a battery disposed within the head mounting element;
a rear facing camera located on the head mounting element; and
an electronic data processor on at least one of the headset body and the head mounting element, the electronic data processor configured to generate at least any one of AR, MR and VR data, and to output said at least any one of AR and MR data to at least one of the first and second lenses, and to output said at least any one of AR, MR and VR data to at least one of the first and second lens covers.
